(19) United States
(12) Patent Application Publication
(10) Pub. No.: US 2015/0284258 A1
(43) Pub. Date: Oct. 8, 2015

(54) Nanoporous Vanadium Oxide Aerogels and Methods of Preparation

(71) Applicant: The Curators of the University of Missouri, Columbia, MO (US)

(72) Inventors: Tyler Martin Fears, Rolla, MO (US); Nicholas Leventis, Rolla, MO (US); Chariklia Sotiriou-Leventis, Rolla, MO (US); Jeffrey G. Winiarz, Rolla, MO (US)

(21) Appl. No.: 14/680,223

(22) Filed: Apr. 7, 2015

Related U.S. Application Data
(60) Provisional application No. 61/995,329, filed on Apr. 8, 2014.

(51) Int. Cl. C01G 31/02; B05D 3/00; B05D 1/00

(52) U.S. Cl. CPC C01G 31/02; B05D 1/005; B05D 3/007

(57) ABSTRACT

The present disclosure provides cost-effective sol-gel methods to produce nanostructured, nanoporous vanadium oxides from inexpensive vanadium halides of the formula VOX₃. In one aspect, a synthetic method for preparing vanadium (IV,V) mixed oxide gels is described comprising epoxide-assisted gelation of a vanadium halide of the formula VOX₃, such as VOCl₃. The resulting aerogels are robust and possess similar morphology and reactivity to gels fabricated via the significantly more costly vanadium alkoxide methods.

### CROSS-REFERENCE TO RELATED APPLICATIONS

This application claims priority under 35 USC §119(e) to U.S. Provisional Patent Application Ser. No. 61/995,329, filed Apr. 8, 2014, the entire disclosure of which is incorporated herein by reference.

### GRANT STATEMENT

This invention was made with Government support under Grant Nos. W911NF-10-1-0476 and W911NF-14-1-0369 awarded by the US Army Research Office. The U.S. Government has certain rights in the invention.

### FIELD OF INVENTION

The present disclosure relates to the field of vanadium oxide materials, more specifically to sol-gel methods to prepare nanostructured, nanoporous vanadium oxide materials which, illustratively, may have applications in electronics, optoelectronics, energy storage, and lightweight structural materials.

### BACKGROUND AND SUMMARY OF INVENTION

Vanadium oxides have garnered attention for their optical, electronic, and catalytic properties as well as high-performance Li-intercalation cathode materials. Vanadium (V) oxide gels are typically synthesized in aqueous environments via acidification of vanadate salts or peroxide-assisted polymerization of bulk V₂O₅. Mixed-valent vanadium (IV,V) oxide gels have been synthesized via controlled hydrolysis of vanadium alkoxides in organic solvents. Whereas vanadium alkoxides are relatively expensive, epoxide-assisted gelation provides an economical alternative to metal alkoxide hydrolysis, which has been shown effective for a large number of transition metal oxides. However, vanadium oxides are conspicuously absent from this group. Accordingly, there is a need to provide a robust and inexpensive method for producing vanadium oxides through a sol-gel method employing inexpensive starting materials; herein is described such a method, wherein vanadium halides are employed.

Also needed are polymeric aerogels having sufficient strength and structural integrity without the need for post-gelation treatment, and efficient methods for their production from readily available starting materials. These needs are addressed in the present disclosure.

The sol-gel method, which commonly involves the hydrolysis of metal alkoxides, is well known to be a versatile synthesis for the fabrication of high-quality metal oxide films, nanostructured powders, and low-density aerogel monoliths. It has been reported that epoxide-assisted gelation is an often desirable alternative to alkoxide hydrolysis, but has been heretofore unrealized for vanadium oxides.

Aqueous vanadium oxide sol-gel chemistry is well-studied and is well-known to serve as the basis on which all vanadia sol-gel chemistry is modeled. While several distinct methods exist for aqueous gelation, it is believed that the first step in all of these methods is the formation of a supersaturated solution of vanadium oxy-hydrates. It is known that this first step can be accomplished using a variety of methods, e.g., quenching molten V₂O₅ in H₂O (oxide hydrolysis); the decomposition of soluble vanadium oxy-peroxide hydrates, such as VO(O₂)(H₂O)₃⁺, VO(O₂)₂(H₂O)₂⁻, and the like (peroxide-assisted hydrolysis); or passing a water-soluble vanadate salt such as NaVO₃ through a proton-exchange column (cation-exchange). These hydrates are believed to speciate as a variety of acidic vanadates with varying degrees of hydration, e.g., VO(OH)₃(H₂O)₂, V₁₀O₂₈⁶⁻, V₆O₁₆²⁻, etc., dependent upon both pH and concentration. The strong anisotropy of the polymerizable, neutral monomeric vanadyl trihydroxy-dihydrate is believed to lead to the formation of vanadyl oxo-polymer chains which aggregate, leading to fibrous gels. This morphology has been reported to be markedly dissimilar from common inorganic gels, which are typified by random aggregates of spherical particles. Variations on these techniques also exist which utilize templating agents to modify gel morphology.

To date, aqueous syntheses have only been shown capable of producing V₂O₅ gels, and related V^{V} gels such as Na₂ₓV₂O₅₊ₓ. Non-aqueous methods have been reported, however, for the production of vanadium oxide (VOₓ) gels with a lower oxidation state. Hydrolysis of organic vanadium species in non-aqueous solvents has been reported to produce high quality VOₓ films and monoliths; e.g., VO₂ films have reportedly been made from the hydrolysis of vanadyl(IV) acetoacetonate in methanol. While organic V^{V} species have been reported to undergo hydrolysis to form oxide gels, partial V^{V}(yellow/red)→V^{IV}(blue/brown) reduction is believed to be nearly universal, presumably due to the requisite organic solvent, resulting in gels with varying degrees of V^{IV} content.

The most commonly reported method for fabricating non-aqueous VOₓ gels is the hydrolysis of vanadyl(V) alkoxides in a water-miscible solvent, e.g., vanadium oxytripropoxide in acetone. Gelation seems to occur extremely rapidly, to be highly exothermic, and to result in light green, highly porous solids. Some alkoxide-derived gels have also been reported to have a unique nanoworm morphology intermediate between the random spherical aggregates commonly seen in metal oxide gels and the monofilament fibers typical of aqueous vanadia gels. While the gelation mechanism is well-studied for aqueous V₂O₅ gels, the speciation and oxo-polymer formation mechanisms in non-aqueous VOₓ gels are less well-studied; this is believed to be due in part to the increased complexity of the system.

Epoxide-assisted gelation has been reported to be effective for a wide range of metal oxides. In this method, it is reported that an epoxide, such as propylene oxide (PPO) or epichlorohydrin (ECH), reacts with an acidic hydrated metal salt, such as a chloride or nitrate, undergoing H⁺-catalyzed irreversible ring-opening by the nucleophilic anions, forming the corresponding alcohol (see Equation 1 below). Epoxide ring-opening gradually raises the pH of the solution by scavenging protons from the acidic metal hydrate, decreasing metal hydrate solubility, leading to uniform supersaturation, followed by olation, oxolation, and dehydration, creating percolating metal oxide networks, i.e., gels. Without being bound by theory, in situ pH measurements on iron(III) and chrome(III) oxide aerogels made from their chlorides and PPO have reportedly been used to support this mechanism. Equation 1 below shows the steps that are believed to be involved in the epoxide-assisted gelation of metal(III) oxides, e.g., those of Fe, Cr, Al. Typically X═Cl, NO₃, and the like, and R═H, Cl, OH, and the like.

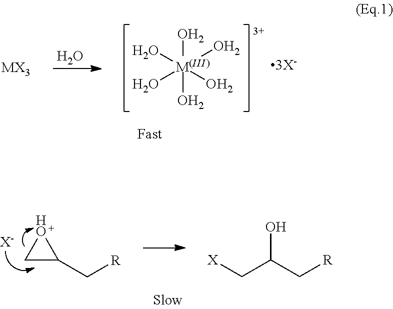

It is believed that the primary advantage of epoxide-assisted gelation is the drastic reduction in reagent cost. Aside from a few examples, e.g., Si, Ti, and Al, metal alkoxides are either prohibitively expensive or commercially unavailable, whereas their salts, such as, illustratively, their chlorides and nitrates, are comparatively inexpensive. PPO and ECH are inexpensive epoxides and have sufficiently different reactivities so as to provide useful control over gelation rates. In addition, metal salts are much less H₂O-sensitive than their alkoxide counterparts, greatly improving ease of handling. Though this method has been successfully used to synthesize aerogels for a large number of metal oxide systems, application toward epoxide-assisted vanadia has remained elusive.

In one embodiment, described herein is a synthetic preparation of vanadium oxides via a low cost, sol-gel, epoxide-assisted gelation of a vanadium halide of the formula VOX₃. In one aspect, the vanadium oxides prepared as described herein are nanostructured; in another aspect, they are nanoporous. Illustrative of the vanadium halide of formula VOX₃ are compounds wherein X═F, Cl, Br, or I. In one aspect, the epoxide is a relatively inexpensive compound such as PPO, ECH, and the like. Without being bound by theory, the synthesis demonstrated herein may be empirically summarized as forming a vanadium alkoxide in situ, as shown in the illustrative equation 2 below, wherein, by way of example, the vanadium halide is vanadium oxytrichloride (VOCl₃) and the epoxide is ECH. Without being bound by theory, it is believed that the vanadium alkoxide thus formed possesses similar reactivity to commonly-used, commercially-available alkoxides.

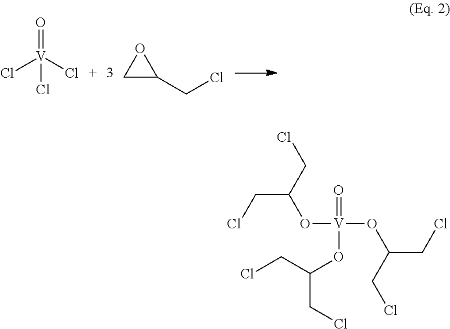

The typical reagent costs given in Table 1 below illustrate the comparatively low cost of the epoxide-assisted gelation described herein as compared with methods involving commonly used vanadium alkoxides.

TABLE 1
A comparison of the cost of commonly used vanadium alkoxides
and illustrative reagents used herein for epoxide-assisted gelation.

| | Cost | Cost | |
|---|---|---|---|
| Reagent | ($/mol) | ($/g V₂O₅) | Purity |
| VO(OiPr)₃ | 3247.86 | 35.71 | — |
| VO(OPr)₃ | 835.18 | 9.18 | 98% |
| VOCl₃ | 81.97 | 0.90 | 99% |
| ECH | 3.14 | 0.10 | ≧99% |

In another embodiment, described herein is a method for the formation of VOₓ aerogels via epoxide-assisted gelation. The formation of VOₓ aerogels is demonstrated herein by using VOCl₃ and ECH, resulting in gels which replicate the physical properties of VOₓ gels fabricated via hydrolysis of vanadium oxytripropoxide, including physical properties such as high surface area, macroporosity, a unique nanoworm morphology, and the ability to form high-strength composite aerogels via isocyanate crosslinking. In addition, several synthetic features unique to this method are observed in the method described herein, including the following: H⁺-free epoxide ring-opening, and discreet multi-step gelation.

In another embodiment, the present invention provides a sol-gel method to prepare nanostructured, nanoporous vanadium oxides from inexpensive vanadium halides. Accordingly, described herein is a synthetic method for preparation of vanadium (IV,V) mixed oxide gels, wherein the method employs epoxide-assisted gelation of VOCl₃. The resulting aerogels are robust and possess similar morphology and reactivity to gels fabricated from vanadium alkoxides.

In another embodiment, the methods described herein for preparing vanadium oxides provide >10-fold reduction in cost of reagents, in comparison to previous technologies. In one aspect, they replace expensive vanadium alkoxides with inexpensive vanadium halides. The methods described herein are especially suited for preparing porous monolithic structures, and are easily adaptable to films, wherein they replace relatively complex physical and chemical vapor deposition techniques with spin and dip coating typically amenable to sol-gel chemistry. These gels also possess the potential for conversion to nanostructured, porous, hard, refractory materials, such as, illustratively, vanadium nitride and vanadium carbide.

One key aspect of the invention herein is that it replaces expensive organic vanadium precursors with cheap inorganic precursors that are either readily available or easily made on site. In addition, the gels produced as described herein are more robust during manufacture than those using previous methods. In another aspect, the gels produced as described herein can be made in a wider variety of densities, up to a factor of 10 lower than the densities obtained by other methods. Films made using the method herein can be made using spin and dip coating techniques, which are much simpler and more economical than commonly used physical and chemical vapor deposition methods. Introducing dopants into sol-gel films is known to be a simple process, whereas it has been reported that doping in vapor deposition methods can be difficult or impossible.

In another embodiment, the VOₓ gels herein may optionally be subjected to crosslinking conditions in bifunctional isocyanate solutions, as is typical for metal oxide gels. The resulting aerogels have noticeably increased density and strength. In one aspect, when crosslinked with aromatic isocyanates and pyrolyzed under NH₃, the gels undergo nitridation. VN aerogels formed this way undergo significant shrinkage, but maintain their monolithic structure.

The vanadium oxides produced by the methods described herein find utility in numerous applications, illustratively: in energy storage, e.g., in Li-intercalation for high performance batteries; as strong lightweight structural materials, e.g., for ballistic armor; in porous refractory materials, e.g., for rocket nosecones; in energy efficient window glazing, e.g., doped VO₂; and in various optical, electronic and optoelectronic applications, such as, illustratively, in applications that take advantage of the metal-to-insulator transition in many of the vanadium oxides.

### DESCRIPTION OF DRAWINGS

FIG. 1 illustrates exemplary dried (left) and annealed (right) VOₓ films deposited onto quartz.

FIG. 2 shows XRD pattern of an annealed VOₓ film.

FIG. 3 illustrates a representative SEM image of annealed VOₓ film on Si.

FIG. 4 illustrates the representative SEM image of annealed VOₓ film cross section on Si.

FIG. 5 displays a SEM image of aero-VOₓ monolith interior.

FIG. 6 displays a TEM image and electron diffraction pattern of aero-VOₓ powder; several crystalline particles are circled in red.

FIG. 7 displays a TGA of xero-VOₓ under He atmosphere.

FIG. 8 displays the UV-Vis absorption spectra of wet gel immediately after gelation and after aging for 36 hrs.

FIG. 9 displays the ¹³C NMR spectrum of wet gels immediately after gelation and after aging 17 hours.

FIG. 10 displays the ⁵¹V NMR spectrum of wet gels immediately after gelation and after aging 17 hours.

FIG. 11 displays the fabrication procedure for (X—)VOₓ aerogels and xerogels. Wet gels are shown in scintillation vials to demonstrate optical quality.

FIG. 12 displays tandem thermogravimetric analysis-mass spectrometry (TGA-MS) data.

FIG. 13 displays UV-Vis absorption spectra of standard epoxide gel during aging.

FIG. 14 displays the following: (A)¹³C Mesophase NMR of wet VOₓ gels; spectra before (red) and after (green) 17 hr aging; (B) reference peak drift during aging.

FIG. 15 displays the concentration (C) of ECH (red), MCPD (orange), MCEP (blue) and their Sum (black) as a function of time (t) as monitored by ¹³C NMR.

FIG. 16 displays ¹H NMR of V^{V} chelates formed in the gelation mixture in the absence of H₂O, compositions given in Table 3. (A) Species formed by reacting with ECH. (B) Effect of VOCl₃ chelation on EtOH ¹H chemical shifts with expanded high-field region to show triplet resolution.

FIG. 17 displays representative (A) SEM and (B) TEM images of VOₓ aerogels. Several crystalline domains are circled in red in the TEM image.

FIG. 18 displays X-ray (Cu—K_{α}) diffraction pattern of ground epoxide aerogel monolith. Electron diffraction pattern inset.

FIG. 19 displays conformally coated cylindrical VOₓ nanoworm approximation used to calculate polymer coating density, where r₁ and r₂ are the radii of the nanoworms and before and after isocyanate crosslinking, respectively and L is the length of the nanoworms.

FIG. 20 displays N₂ isotherms and inset pore distribution of VOₓ xerogel (black), VOₓ aerogel (blue), and X—VOₓ.

FIG. 21 displays TGA-MS results for VOₓ aerogels (A) and xerogels (B). TGA signal is normalized to the final mass, in order to represent losses as a proportion of the VOₓ matrix, which becomes V₂O₅ in all cases.

FIG. 22 displays: (A) Photo, and (B) SEM image of VO₂ film, showing optical clarity and nanoscopic uniformity.

FIG. 23 displays collected (black) and calculated (red) x-ray (Cu—K_{α}) diffraction pattern for annealed VO₂ films on fused silica.

FIG. 24 displays measurement of the metal-to-insulator transition of fabricated ˜150 nm VO₂ thin film on a quartz substrate.

FIG. 25 displays representative quasi-static compression tests of X—VOₓ aerogels with different densities, as controlled by isocyanate concentration in crosslinking solutions. Elastic region expanded in inset. Protocols were followed as previously reported in the literature.

### DETAILED DESCRIPTION

Before the present methods, implementations and systems are disclosed and described, it is to be understood that this invention is not limited to specific methods, specific components, implementation, or to particular compositions, and as such may, of course, vary. It is also to be understood that the terminology used herein is for the purpose of describing particular implementations only and is not intended to be limiting. Neither are explanations that have been provided to assist in understanding the disclosure meant to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance may or may not occur, and that the description includes instances where said event or circumstance occurs and instances where it does not.

In one embodiment, the present disclosure describes wet gels that are obtained by mixing a vanadium halide of the formula VOX₃, water, and one or more than one acid scavenging species in an appropriate water-miscible organic solvent at an appropriate reaction temperature, and allowing the liquid solution to form a gel monolith. These gels are then washed in a solvent bath to remove unreacted materials, and then are supercritically dried to obtain aerogels. Illustrative of the vanadium halide of formula VOX₃ are compounds wherein X═F, Cl, Br, or I. Illustrative of the acid scavenging species are 1,2-epoxide compounds or 1,3-epoxide compounds, such as propylene oxide, epichlorohydrin, glycidol, and dimethyloxetane, and the like. Illustrative of the appropriate water-miscible organic solvent are organic solvents such as ethanol, methanol, isopropanol, n-butanol, dimethylformamide, and the like, and mixtures thereof. Illustrative of the appropriate reaction temperature are temperatures in the range of from about −78° C. to about 25° C. Illustrative of the solvent bath is any solvent, typically polar, that is miscible with the utilized organic reagents and byproducts and that has an accessible supercritical point, such as, illustratively, ethanol, and the like. Alternatively, the solvent bath may be any solvent, typically polar, that is miscible with the utilized organic reagents and byproducts, and that can subsequently be exchanged with another fluid that has an accessible supercritical point, such as, for example, acetone, acetonitrile, and the like.

In another embodiment, the present disclosure provides a general sol-gel method to produce nanostructured nanoporous vanadium oxides from inexpensive vanadium halides. This method includes the steps of (i) obtaining wet gels by mixing a vanadium halide, illustratively, VOCl₃, water, and one or more than one acid scavenging species in an appropriate water-miscible organic solvent, at an appropriate reaction temperature, and allowing the liquid solution to form a gel monolith; (ii) washing the gels in a solvent bath to remove unreacted materials; and, (iii) supercritically drying the washed wet gels, such as, illustratively, from ethanol or CO₂, and the like, to obtain aerogels. Illustrative of the acid scavenging species are 1,2-epoxide compounds or 1,3-epoxide compounds, such as propylene oxide, epichlorohydrin, glycidol, and dimethyloxetane, and the like. Illustrative of the appropriate water-miscible organic solvent are organic solvents such as ethanol, methanol, isopropanol, n-butanol, dimethylformamide, and the like, and mixtures thereof. Illustrative of the appropriate reaction temperature are temperatures in the range of from about −78° C. to about 25° C. Illustrative of the solvent bath is any solvent that is miscible with the utilized organic reagents and byproducts and that has an accessible supercritical point, for example, ethanol, and the like, or a solvent that can subsequently be exchanged such as, for example, acetone or acetonitrile.

In another embodiment, the present disclosure provides a general sol-gel method to produce vanadium oxide films from inexpensive vanadium halides. This method includes the steps of (i) mixing a vanadium halide, illustratively, VOCl₃, water, and acid scavenging species in an appropriate solvent at an appropriate temperature to form a stable solution, as described in the foregoing; (ii) aging the solution at room temperature for an appropriate period of time, illustratively, 4 days, to affect vanadium reduction, e.g., 4 days; (iii) depositing the solution onto a substrate via spin coating to form a film; and, (iv) drying the film at a suitable temperature, for example, 70° C., for an appropriate period of time, for example, 15 minutes, to effect complete hydrolysis and densification.

In another embodiment, an alternative method is provided herein to produce vanadium oxide films from inexpensive vanadium halides. This method includes the steps of (i) preparing a stable solution identical to the one described above for making aerogels, but without the H₂O; (ii) spin coating the solution onto a substrate, wherein the solution undergoes partial hydrolysis from ambient moisture to form soft films; (iii) drying in air at an appropriate temperature, for example, 150° C., for an appropriate period of time, for example, 20 minutes; and, (iv) annealing under dry N₂ at an appropriate temperature, for example, 400° C., for an appropriate period of time, for example, 2 hours, to form hard, high-quality films.

In a related aspect, the methods herein allow for production of vanadium oxide films without the need for using a reducing atmosphere in their production.

In another related aspect, the methods herein allow for annealing the dry gels in a furnace under various atmospheres, illustratively including, but not limited to, Ar, N₂, O₂, H₂, vacuum, and NH₃, resulting in the formation of various vanadium oxides, vanadium nitride, and vanadium carbide.

In another embodiment, described herein are wet epoxide gels prepared by the above methods. In one aspect, these epoxide gels are sturdier (easier to handle during washing) and exhibit less optical scattering than their alkoxide counterparts. In another aspect, the X—VOₓ epoxide aerogels prepared herein possess mechanical properties similar to the mechanical properties of X—VOₓ alkoxide aerogels.

In another embodiment, the VOₓ aerogels fabricated herein via epoxide-assisted gelation utilizing VOX₃ and an epoxide resemble those fabricated via alkoxide hydrolysis, but at approximately 1/10 of the cost. In one aspect, the epoxide gels herein, as wet gels, are superior to their alkoxide counterparts in both optical quality and robustness. In another aspect, the VOₓ films produced herein are denser and more highly uniform than those made via alkoxide hydrolysis methods.

In another embodiment, the VOₓ films and aerogels fabricated herein, via epoxide-assisted, mimic those fabricated via the hydrolysis of vanadium oxytripropoxide while reducing reagent cost by a factor of 10. By way of illustration, certain aerogels fabricated herein, utilizing VOCl₃ and epichlorohydrin, possessed a macroporous nanoworm morphology, a density of 0.103 g/cm³, 96.9% porosity, a specific surface area of 102.0 m²/g, and ˜18% reversible hydration capacity by mass.

In another embodiment, described herein is a method for preparing vanadium oxide aerogels comprising the steps of: (i) obtaining wet gels by mixing a vanadium halide of the formula VOX₃, water, and one or more acid scavenger species in one or more appropriate solvent at an appropriate temperature and allowing the liquid solution to form a gel monolith; (ii) washing the gels in a solvent bath to remove unreacted materials; and, (iii) critically drying the washed wet gels to obtain aerogels; wherein X is a halogen. In one aspect, X═Cl. In another aspect, the one or more acid scavenger species is an epoxide, which may be selected from the group consisting of epichlorohydrin, propylene oxide, glycidol, and dimethyloxetane. A preferred epoxide is epichlorohydrin. In another aspect, the one or more appropriate solvent is a water-miscible organic solvent that does not decompose upon contact with the vanadium halide of the formula VOX₃. In another aspect, the solvent is an alcohol. In another aspect, the solvent is ethanol. In another aspect, the appropriate temperature is a temperature in the range of from about −78° C. to about 25° C. In another aspect, the solvent in the solvent bath is a fluid that is miscible with the utilized reactants and byproducts and that has an accessible supercritical point, or that can be exchanged with another fluid that has an accessible supercritical point. In another aspect, the solvent in the solvent bath is a ketone. In another aspect, the solvent in the solvent bath is acetone.

In another embodiment, described herein is a method for preparing vanadium oxide aerogels as described in the preceding paragraph, the method further comprising the step of subjecting the gels to crosslinking conditions in bifunctional isocyanate solutions.

In another embodiment, described herein is a method for preparing vanadium oxide films comprising the steps of: (i) obtaining a stable solution by mixing a vanadium halide of the formula VOX₃ and one or more acid scavenger species in one or more appropriate solvent at a temperature of from about −78° C. to about 25° C.; (ii) spin coating the solution onto a substrate to form soft films; (iii) drying in air at a temperature of from about 50° C. to about 200° C., for a time period of from about 5 minutes to about 30 minutes; and, (iv) annealing under dry N₂ at a temperature of from about 350° C. to about 500° C. for at least 1 hour; wherein X is a halogen. In one aspect, the one or more acid scavenger species is an epoxide. In another aspect, the epoxide is selected from the group consisting of epichlorohydrin, propylene oxide, and glycidol. In a preferred embodiment, the epoxide is epichlorohydrin. In another aspect, the one or more appropriate solvent is an organic solvent that is miscible with the vanadium halide of the formula VOX₃, the one or more acid scavenger species, and the resulting stable solution, without undergoing decomposition. In another aspect, the appropriate solvent is selected from the group consisting of ethanol, dimethylformamide, and CCl₄.

In another embodiment, described herein is a vanadium oxide aerogel prepared by a process comprising the steps of: (i) obtaining wet gels by mixing a vanadium halide of the formula VOX₃, water, and one or more acid scavenger species in one or more appropriate solvent at an appropriate temperature and allowing the liquid solution to form a gel monolith; (ii) washing the gels in a solvent bath to remove unreacted materials; and, (iii) critically drying the washed wet gels; wherein X is a halogen.

The following examples are provided for the purpose of illustration only, and it is to be understood that they are not intended to be limiting, but that other modifications that are known to those skilled in the art, and that are within the scope and spirit of the disclosure herein, may be used as well.

### EXAMPLES

All chemicals were used as received from commercial sources without further purification.

### Example 1

### Exemplary Monolith Synthesis

0.180 mL (1.9 mmol) VOCl₃ is dissolved in 1 mL ethanol in a 20 mL scintillation vial. In a separate vial, 0.744 mL (9.5 mmol) epichlorohydrin and 0.411 mL (22.8 mmol) H₂O are dissolved in 1 mL ethanol. Both solutions are cooled to 0° C. Solutions are poured together and swirled to mix before pouring into the desired molds. The gel formed is allowed to age at room temperature for 5 days before washing. Gels are washed via submersion in acetone baths >4 times gel volume for 8 hours. This is repeated three times. Gels are dried in a supercritical CO₂ dryer.

Variations on this procedure to affect gelation time and morphology include modifying reagent concentrations (for example, 0.090 mL VOCl₃ to 0.0090 mL VOCl₃ per mL ethanol), ratios (for example, epoxide and H₂O to VOCl₃ molar ratios from 3 to 50 and 6 to 200, respectively), and chemical identities (for example, alternative epoxides or alternative vanadium salts); temperature (for example, −78° C. to 25° C.); post-gelation aging time (for example, 1 day to 14 days); and solvent (for example, methanol, isopropanol, dimethylformamide, and the like). Between the washing and drying steps, crosslinking via submersion in an isocyanate solution can produce mechanically strong, lightweight materials. Use of a weak acid scavenging cyclic ether, for example, tetrahydrofuran, and the like, results in a stable sol appropriate for film fabrication.

### Example 2

### Exemplary Film Synthesis

0.180 mL (1.9 mmol) VOCl₃ is dissolved in 2 mL ethanol in a 20 mL scintillation vial to which is added 0.770 mL (9.5 mmol) tetrahydrofuran and 0.411 mL (22.8 mmol) H₂O. This solution is aged at room temperature for 4 days before deposition onto a 25.4 mm diameter quartz substrate via spin coating. The film is then dried in a 70° C. oven for 15 minutes to affect complete hydrolysis and densification.

### Example 3

### Alternative Exemplary Film Synthesis

The film may be made by spin coating a sol containing VOCl₃ (0.180 mL, 1.90 mmol) and epichlorohydrin (0.744 mL, 9.50 mmol) in ethanol (2 mL). This solution is identical to that used to make aerogels, but without H₂O. Precursor solution undergoes partial hydrolysis from ambient moisture to form soft films. These are then dried in air (150° C., 20 min) and annealed under dry N₂ (400° C., 2 hr) to form hard, high-quality films.

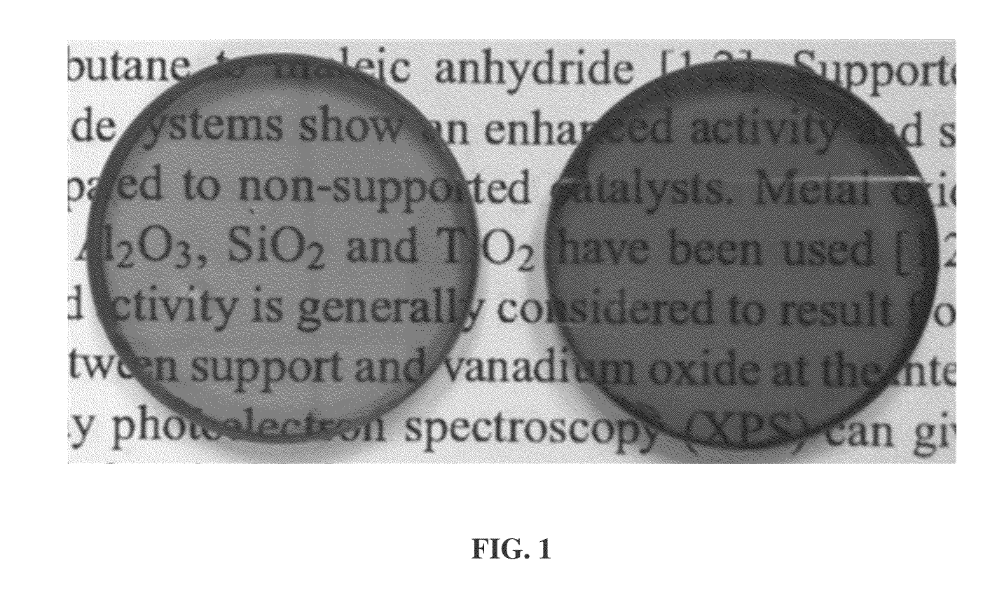

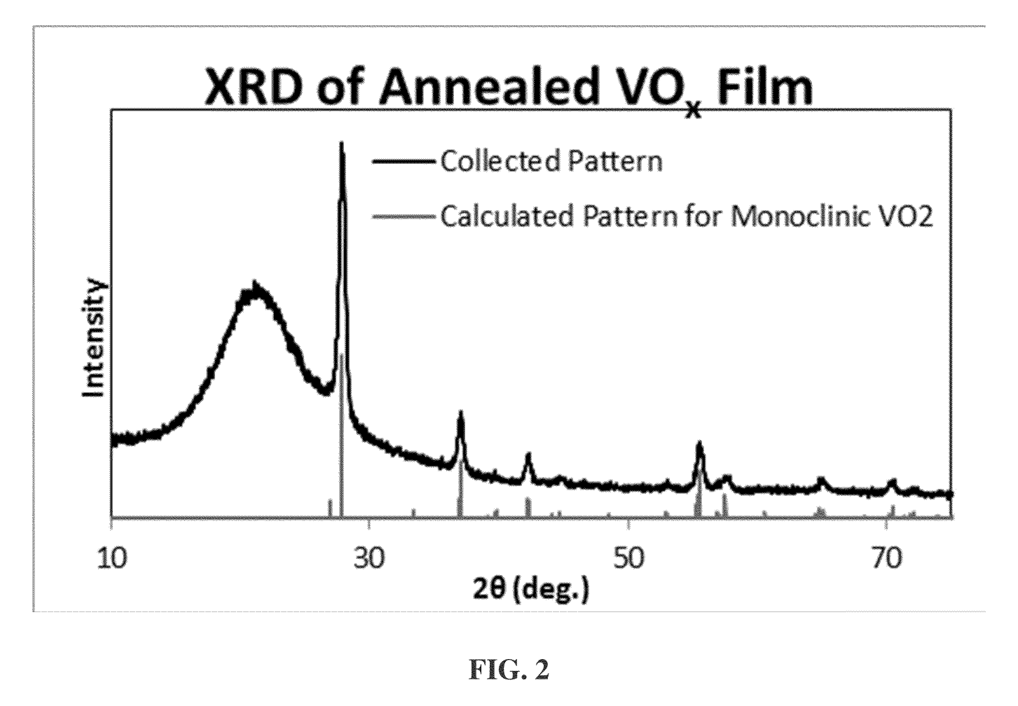

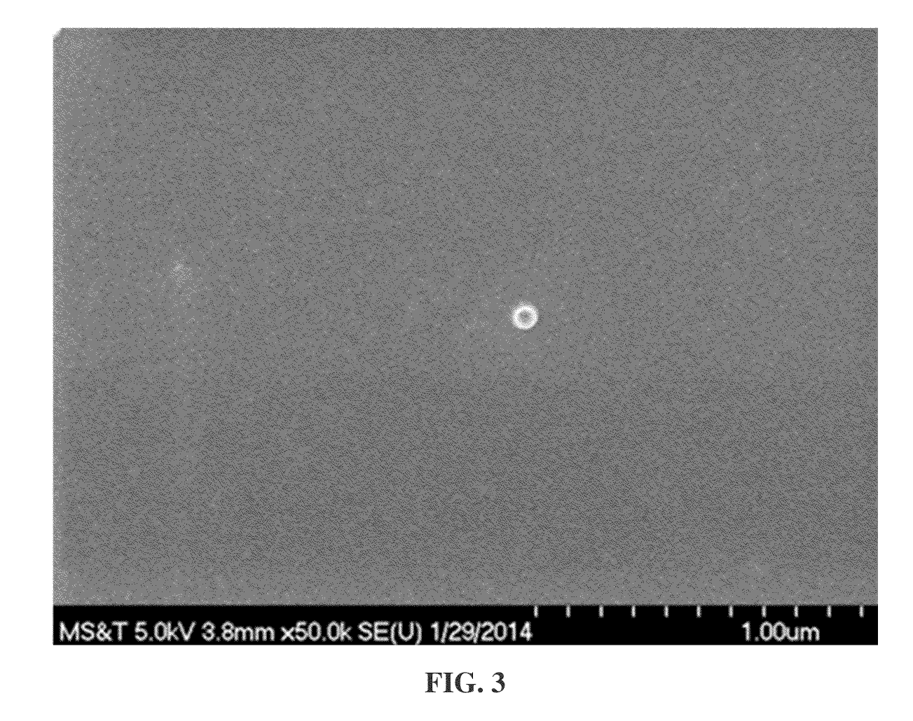

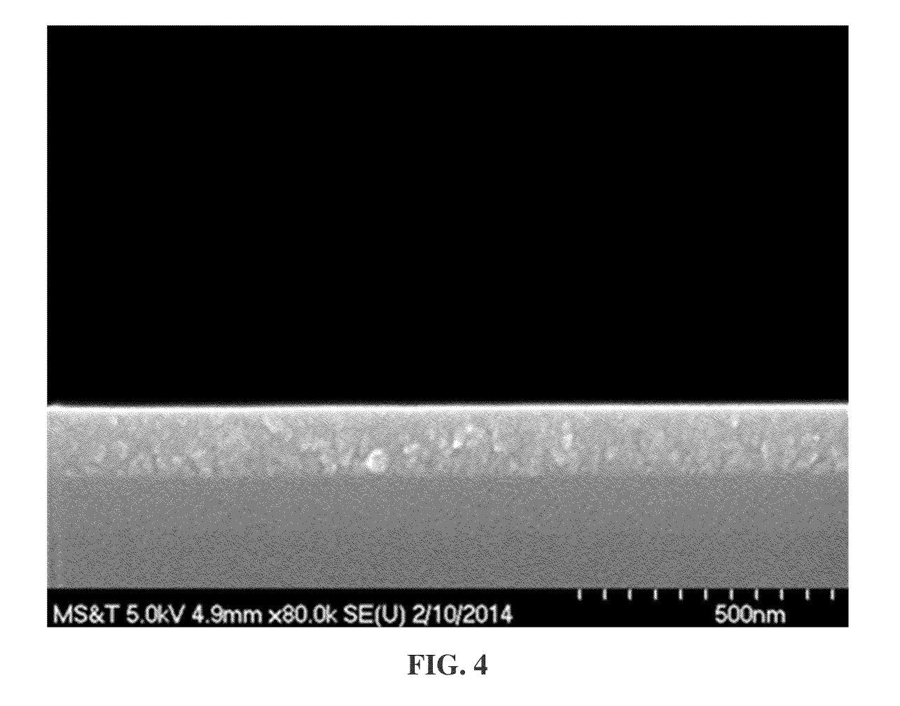

This procedure most closely follows the literature procedure of Guzman et al. (“Synthesis of vanadium dioxide thin films from vanadium alkoxides,” Materials Research Bulletin 1994, 29, 509-515), but replaces expensive vanadium alkoxide precursors with the vanadium chloride and epichlorohydrin to produce an in-situ alkoxide for hydrolysis at approximately one-tenth of the cost. The annealed films appear visually identical (FIG. 1) and possess the appropriate crystalline morphology as determined by XRD (FIG. 2) for thermochromism as seen by Guzman. The XRD pattern matches that of monoclinic VO₂, and may be expected to be thermochromic. The SEM images show that these films are exceedingly and uniformly smooth (FIG. 3), homogeneous, and of uniform thickness of ca. 150 nm (FIG. 4); they appear to be dense and polycrystalline with small grains. These are similar to the films of Guzman and superior to films made using other methods. These VO₂ films are also produced without the need for a reducing atmosphere, as used by Guzman, and at a slightly lower temperature. The sporadic aberrations (spherical particle) in FIG. 3 may possibly be attributed to dust present during spin coating or annealing.

Physical deposition methods for films including CVD, APCVD, RF sputtering, etc., are known to be much more complicated than their sol-gel counterparts and require specialized equipment. Sol-gel methods can be used to deposit films in a number of simple ways, including spin coating, dip coating, and drop casting. Additionally, doping films to change (lower) the metal-to-insulator transition, e.g., for thermochromic window coatings, is known to be exceedingly easy, unlike physical deposition methods. VO₂ films are also commonly fabricated using the sol-gel method via hydrolysis of vanadyl acetylacetonate (VO(acac)₂), which is a V^{IV} reagent, and consequently is known to be more expensive.

The sol-gel chemistry involved makes gels amenable to doping with various soluble metal salts to affect final composition and material properties. Annealing dry gels in a furnace under various atmospheres including, but not limited to, Ar, N₂, O₂, H₂, vacuum, and NH₃ are known to controllably affect the composition of the material, allowing the formation of various vanadium oxides, vanadium nitride, and vanadium carbide.

One main advantage to using the inventive method described herein over the alkoxide method is cost. The precursor solution for the alkoxide method is very stable in the absence of H₂O and can tolerate small amounts of H₂O without significant decomposition, whereas the traditional alkoxide solutions are known to be extremely intolerant of H₂O.

### Example 4

### Aerogel and Xerogel Synthesis

Materials.

All chemicals were used as received without further purification unless otherwise noted, including VOCl₃, epichlorohydrin (ECH), absolute ethanol (EtOH), HPLC-grade acetone, HPLC-grade ethyl acetate (EtOAc), 95-98% H₂SO₄, KMnO₄, sodium oxalate, deionized (DI) water. Desmodur N3200A (oligomeric hexamethylene diisocyanate) and Desmodur RE (27% by weight tris(p-isocyanatophenyl)methane (TIPM) in EtOAc) were obtained from Bayer Corporation.

In a typical synthesis, 0.540 mL (5.7 mmol) VOCl₃ was dissolved in 3.0 mL EtOH. The resultant deep red solution (A) was cooled to 0° C. in an ice bath. In a separate vessel, 2.25 mL (28.7 mmol) ECH and 0.925 mL (51.3 mmol) H₂O was dissolved in 3.0 mL EtOH cooled to 0° C. The resultant solution (B) was cooled to 0° C. in an ice bath. Solutions A and B were mixed vigorously, and poured into 10 mL cylindrical polypropylene molds, forming a deep red, non-scattering gel in a matter of seconds. Wet-gels were allowed to age for 5 days, becoming dark green in the process. The gels were then placed in an acetone bath of at least 4 times their total volume to remove unreacted starting reagents. The bath was replaced with fresh acetone every 8 hours until the gels had undergone 4 washes.

Xerogels were formed by drying washed wet-gels under vacuum at 50° C. Aerogels were formed by drying gels in a Spe-ed SFE supercritical fluid CO₂ dryer from Applied Separations. Gels dried by these methods are referred to as xero-VOₓ and aero-VOₓ respectively.

The gels undergo crosslinking in bifunctional isocyanate solutions, as is typical for metal oxide gels. The resulting aerogels have noticeably increased density and strength. When crosslinked with aromatic isocyanates and pyrolyzed under NH₃, the gels undergo nitridation (confirmed by XRD), another common occurrence in nanoporous metal oxides. VN aerogels formed this way undergo significant shrinkage, but maintain their monolithic structure.

Thus, crosslinked gels (X—VOₓ) were obtained by replacing the fourth acetone wash with a solution of 11.0 g Desmodur N3200A in 94 mL acetone. The gels were aged for 1.5 days at room temperature followed by 3 days at 55° C. The gels were then cooled to room temperature and washed in acetone baths followed by drying as previously noted. VN gels were prepared by replacing the third gel wash with EtOAc, followed by crosslinking with a solution of 41.0 g Desmodur RE in 61 mL EtOAc. Gels were then washed in acetone baths until baths were clear. Gels were supercritically dried and pyrolyzed under NH₃ at 800° C.

### Example 5

Material Characterization.

Unless otherwise mentioned, all gels were characterized in powdered form. Native VOₓ and VN powders were prepared by grinding dried gels in a mortar and pestle. X—VOₓ powders were prepared by breaking monoliths into chunks using a mortar and pestle followed by pulverizing gels in a SPEX SamplePrep 8000D ball mill using ½ in. stainless steel ball bearings.

### Example 6

### Chemical Analysis

Thermogravimetric analysis (TGA) was carried out under He and O₂ atmospheres on a TA Instrument, model Q50. The temperature was raised from room temperature to 700° C. at 5° C./min. Tandem thermogravimetric analysis-mass spectrometry (TGA-MS) was performed from room temperature to 700° C. at 10° C./min under flowing Ar.

Total vanadium content was determined using an inductively-coupled plasma mass spectrometer (ICP-MS). Samples were prepared by digesting VOₓ in aqueous HNO₃. C and H content was determined using a PerkinElmer CHN/O Analyzer.

V^{IV} content was determined via redox titration. 25.00 mg VOₓ was dissolved in 0.1 mL 95-98% H₂SO₄ and 10 mL H₂O. The green VOₓ solution was titrated with 2.2 mM aqueous KMnO₄ with heating and stirring. KMnO₄ was standardized against acidified aqueous sodium oxalate.

### Example 7

### Electron Microscopy

Scanning electron microscopy (SEM) was performed on aerogel cross-sections on a Hitachi S-4700 field emission microscope. Transmission electron microscopy (TEM) and electron diffraction were performed on a Tecnai F20 STEM.

### Example 8

### X-Ray Diffraction

X-ray diffraction (XRD) was performed on a PANalytical X'Pert Pro Multi-Purpose Diffractometer with a Cu Kα radiation source (λ=1.54 Å).

### Example 9

### Porosity

N₂ porosimetry was performed on an ASAP 2020 surface area and porosity analyzer. Surface area (a) was determined by the Brunauer-Emmett-Teller (BET) method from the N₂ adsorption isotherm. Bulk aerogel densities were calculated from monolith weight and dimensions.

### Example 10

### UV-Vis Absorption Spectroscopy

UV-Vis absorption spectra was collected using an Ocean Optics Chem 2000 UV-Vis with a Deuterium-Tungsten lamp. 20-30 m path-length soda-lime cuvettes were fabricated in-house. Solutions A and B were thoroughly mixed and immediately transferred to cuvettes before gelation. Cuvettes were sealed with Parafilm to prevent solvent evaporation and monitored for 48 hours.

### Example 11

### Nuclear Magnetic Resonance

Mesophase ¹³C (100.6 MHz) and ⁵¹V (105.2 MHz) nuclear magnetic resonance (NMR) spectra were collected on a 400 MHz Varian Unity INOVA spectrometer. Solutions A and B were thoroughly mixed and transferred to a 5 mm NMR tube and allowed to gel. The tube was sealed with PTFE tape to prevent solvent loss and allowed to age.

### Example 12

### Results

X—VOₓ gels are very tough, requiring extensive grinding in a ball mill to reduce samples to powder form. Native VOₓ gels were fragile by comparison, but are sufficiently strong to survive gentle handling without fracture before and after drying.

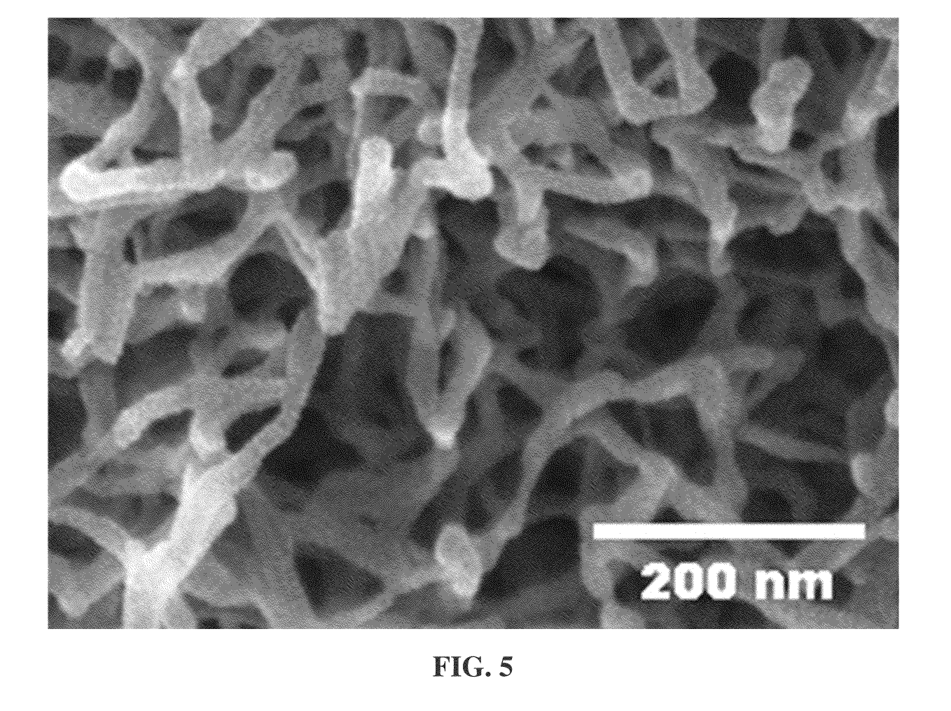

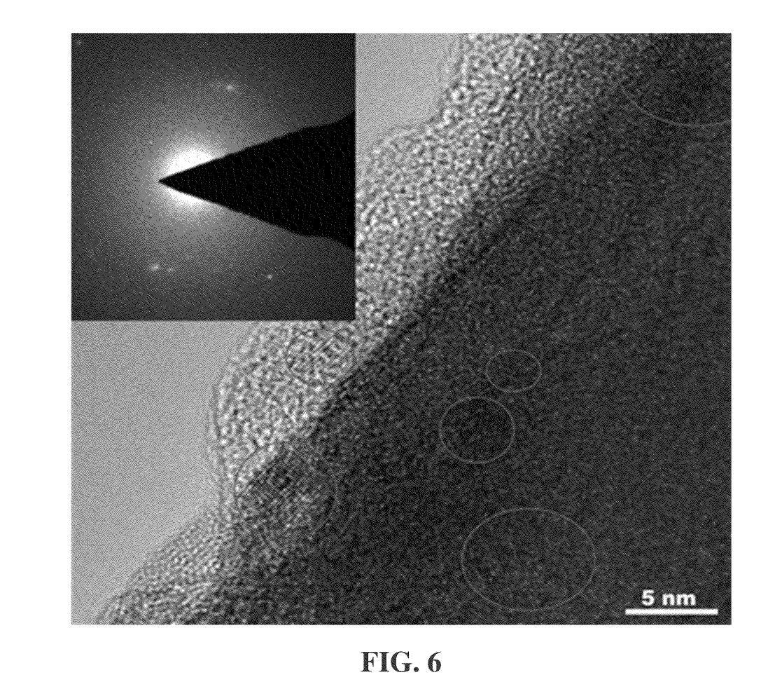

SEM shows an aerogel nanomorphology consistent with that obtained from hydrolysis of VO(OCH₂CH₂CH₃)₃ in acetone (FIG. 5). TEM shows small, crystalline, approximately spherical particles embedded in an amorphous matrix (FIG. 6). XRD confirms that as-synthesized gels are amorphous, with a characteristic layer spacing typical of amorphous vanadium oxides.

The nanomorphology of gels synthesized via the epoxide-synthesized gelation herein is consistent with that of gels previously reported to have been made from hydrolysis of VO(OCH₂CH₂CH₃)₃. This is in contrast to uniform fibrous V₂O₅ typically seen from aqueous synthesis or low-valent vanadium oxide materials synthesized via hydrothermal reduction. TEM indicates that the product is largely amorphous and studded with crystalline particles. The electron diffraction pattern supports this: a sample composed of small crystalline particles will exhibit diffraction rings, while large particles would exhibit a single-crystal-like diffraction pattern. Additionally, this is reinforced by the x-ray diffraction patterns of VOₓ samples which has only broad, shallow peaks.

Density, surface area, and porosity data for gels is shown in Table A. Bulk density of xerogels could not be obtained due to the irregular shapes of dried monoliths.

TABLE A
Microstructural and density data for VOₓ samples.

| | Bulk Density | Skeletal | BET Surface | |
|---|---|---|---|---|
| Sample | (g/mL) | Density (g/mL) | Area (m²/g) | Porosity |
| Xero-VOₓ | — | 2.67 | 0.31 | — |
| Aero-VOₓ | 0.103 | 3.30 | 102.0 | 96.9% |
| Aero-X-VOₓ | 0.412 | 1.32 | 81.9 | 68.8% |

The total vanadium content determined via TGA (ICP-MS) under O₂ is 7.98 mmol/g. V^{IV} content determined via permanganometry is 5.52 mmol/g. These results are summarized in Table B.

TABLE B
Concentration of vanadium calculated from various methods and
the resulting average oxidation state.

| | Total V | V (4+) | V (5+) | Average |
|---|---|---|---|---|
| Method | (mmol/g) | (mmol/g) | (mmol/g) | Oxidation State |
| Permanganometry | — | 5.52 | — | — |
| TGA | 7.98 | — | — | 4.31 |
| ICP-MS | 8.27 | — | — | 4.33 |

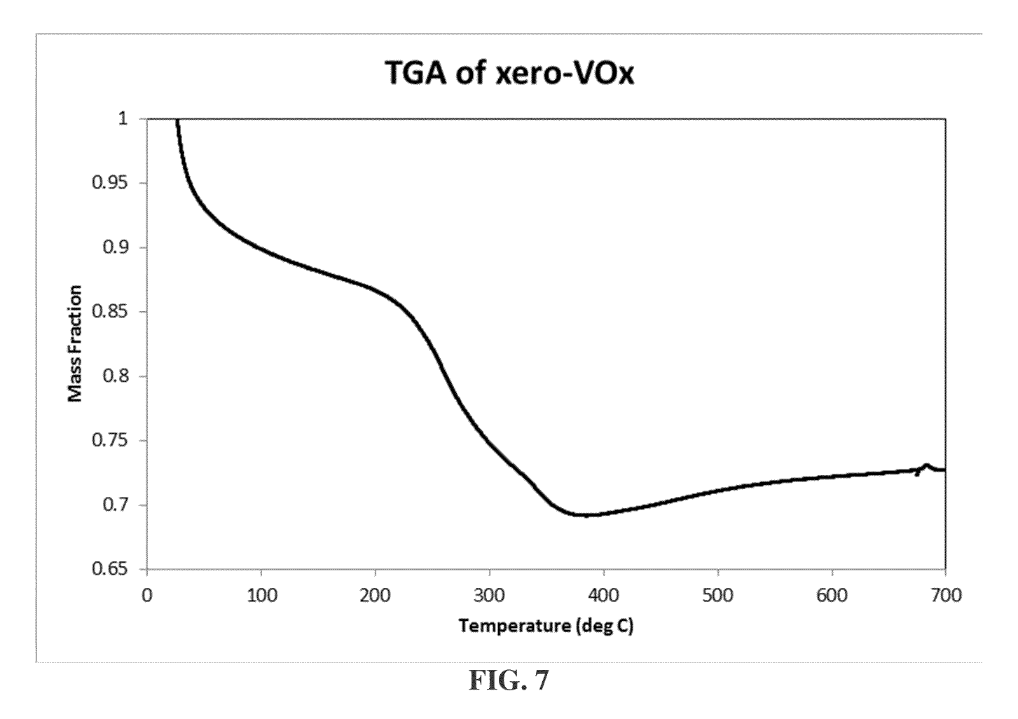

TGA under He indicates two prominent losses of ca. 14% (by mass) up to 200° C. and an additional ca. 15% up to 300° C. as seen in FIG. 7. Elemental analysis indicates that VOₓ contains 4.4% C and 1.7% H by weight. An additional mass loss can be seen between 300 and 400° C. Without being bound by theory, it is possible that mass gain above 400° C. may be due to residual O₂ or H₂O in balance gas that leaked into sample chamber. “Bump” in data near 700° C. may possibly correspond to a switch in flow gas from He to O₂.

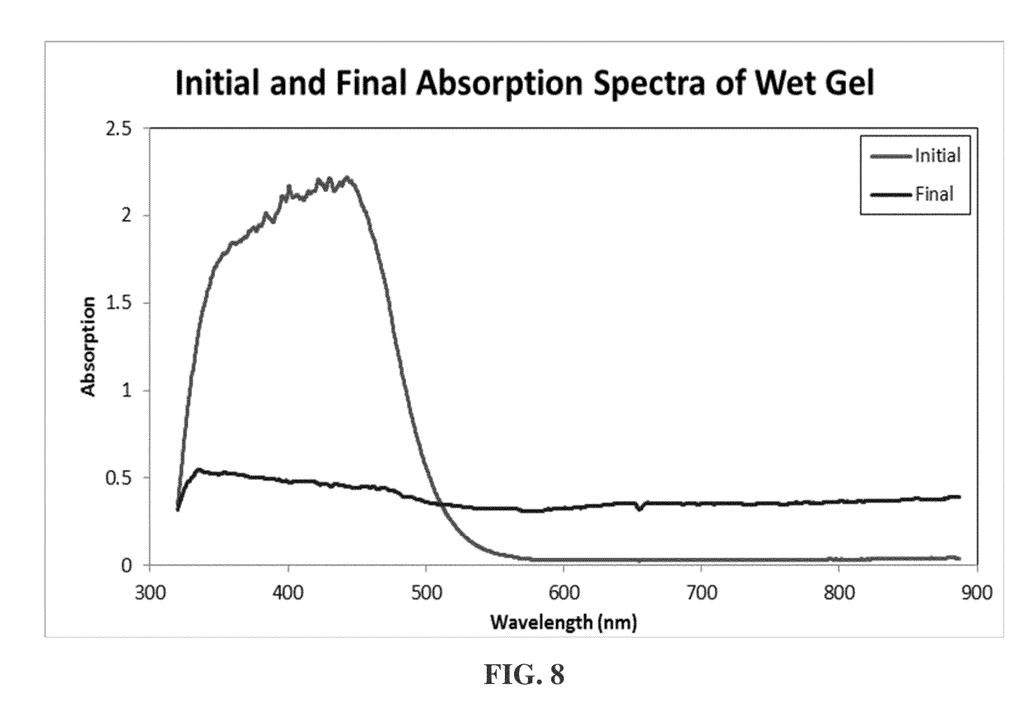

Gelation takes effect in under 10 seconds, forming a red, optically non-scattering solid. The gels then undergo a color change, forming a dark green product as seen in FIG. 8. This color change was monitored via UV-Vis absorption spectroscopy. Spectra of initial red species and final green species are shown in FIG. 8.

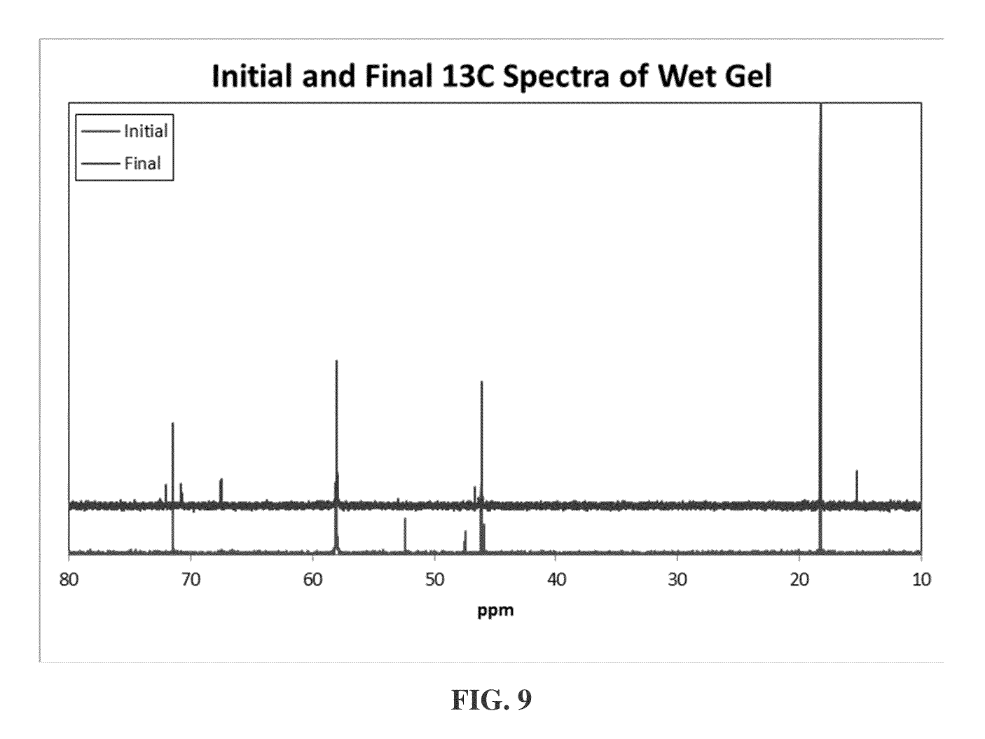

¹³C mesophase NMR spectra collected immediately after gelation and after 3 days aging are shown in FIG. 9. Using commercially available standards, EtOH, Epichlorohydrin, and 1,3-dichloro-2-propanol are readily identified in FIG. 9. 3-Chloro-1,2-propanediol was also identified in aged gels, but the low concentration of the species makes it less obvious. The additional species developed during aging was identified via GC-MS as 1-chloro-3-ethoxy-2-propanol. Vanadium species have been reported to undergo reduction in acidic environments in the presence of suitable organic species, but the presence of the acid-scavenging epoxide ensures that the environment is neutral.

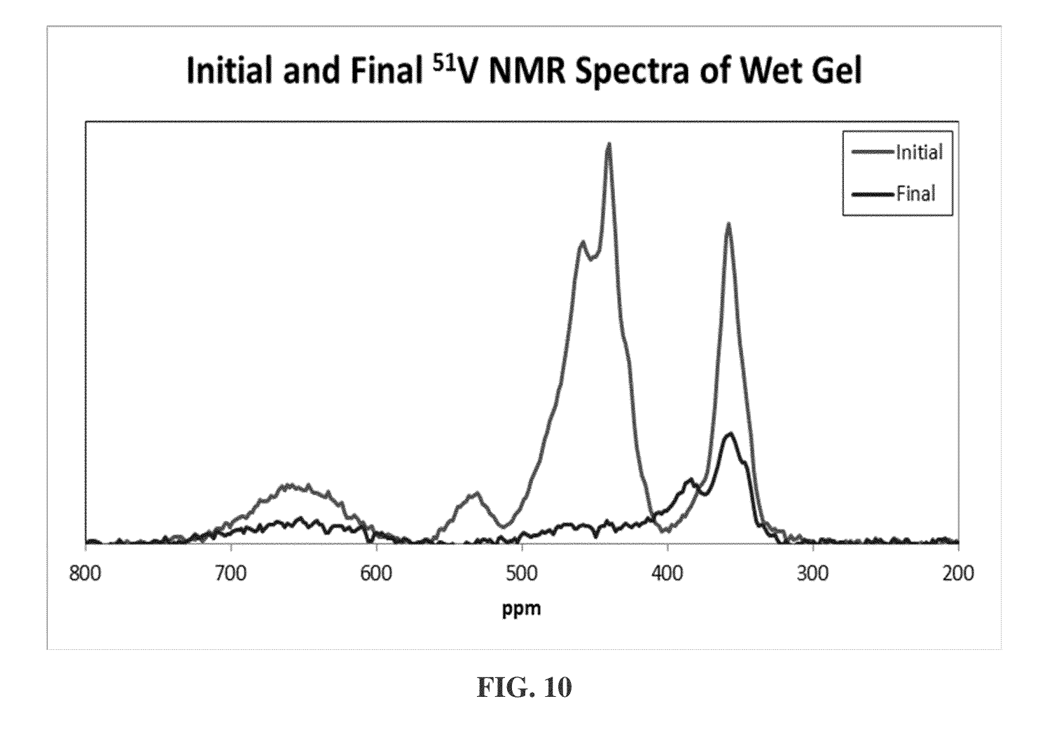

⁵¹V mesophase NMR spectra collected immediately after gelation and after 3 days aging are shown in FIG. 10. A large number of vanadium intermediates can be seen in these ⁵¹V mesophase NMR spectra, and that the concentration of these intermediates changes during aging. Without being bound by theory, it is possible that precipitation of soluble compounds and reduction of V^{V} to paramagnetic V^{IV} species may represent the two mechanisms for loss.

### Example 13

### Additional Observations

N₂ sorption isotherms indicate that the aerogels are macroporous with a moderate surface area relative to other aerogel materials. Xerogel surface area was too low to measure accurately. Conformal polymer coating of the aerogel microstructure leads to a decrease in surface area and porosity. This decrease in porosity may have been aided during pulverization, due to the plastic nature of crosslinked gels. Other methods of grinding the gels that would not collapse the microstructure were frustrated by the gels' toughness and plasticity; even inducing brittleness with cryogenic temperatures is ineffective, as it has been reported elsewhere that X—VOₓ gels retain their plasticity under cryogenic conditions.

Previously, VOₓ gels obtained via hydrolysis of VO(CH₂CH₂CH₃)₃ were said to be amorphous H₂V₃O₈; however, the average oxidation state determined for the material synthesized via epoxide-assisted gelation suggests that it is not a stoichiometric mixed oxide. The C and H content of the gels can be best ascribed to 21.9% CO₃²⁻ and 15.2% H₂O, respectively. These species would give rise to mass loses of 16.1% (CO₂) and 15.2% (H₂O), which are consistent with that seen in TGA. Ascribing carbonaceous content to ethoxy or acetate species could only account for 14% or 20% total mass loss, rendering these possibilities unlikely. TGA-MS confirms dehydration below 200° C. and carbonate decomposition through CO₂ loss below 300° C.

The observation that the gelation takes place in such a short period of time leads to great difficulty in monitoring the gelation process. The gel color change attributed to V^{V}-V^{IV} reduction takes place on the timescale of hours and can be monitored by various methods.

The predicted levels for organic oxidation products is below the level of detection in ¹³C NMR under the conditions available. Acetaldehyde can be identified in the vapor by its distinctive smell (like apples), but remains elusive in GC-MS. Small amounts of other species can also be seen in GC-MS, which, without being bound by theory, are tentatively ascribed to oxidized chlorinated alcohols formed during gelation and aging.

### ADDITIONAL EXAMPLES

### Example 14

### Aerogel and Xerogel Fabrication

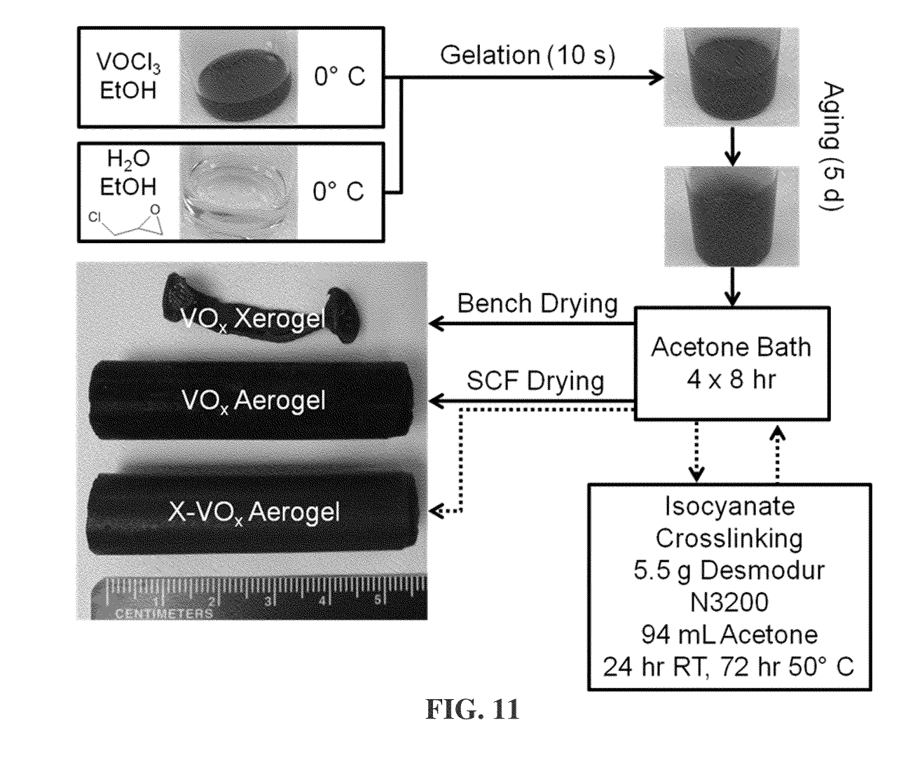

The synthesis of VOₓ and isocyanate crosslinked (X—VOₓ) aerogels and xerogels is summarized in FIG. 11. A typical gel was fabricated as follows: 0.540 mL (5.71 mmol) VOCl₃ (99%, Strem Chemicals) was dissolved in 3 mL absolute ethanol (EtOH) (200 proof, LyondellBasell) and cooled to 0° C. in an ice bath. In a separate container, 2.25 mL (28.6 mmol) ECH (99%, Acros Organics) and 0.925 mL (51.4) deionized H₂O was dissolved in 3 mL EtOH and cooled to 0° C. in an ice bath. The two solutions were mixed and swirled vigorously before immediately pouring into syringe molds. Within 10 seconds, solid red gels formed, which were aged for 5 days at ambient temperature before washing. PPO (≧99%, Sigma-Aldrich), glycidol (GLY) (96%, Acros), and dimethyloxetane (DMO) (98%, Sigma-Aldrich) were substituted for ECH in some cases to investigate their effects on gelation rate.

Washing and isocyanate crosslinking procedures were followed according to those previously reported in literature. Gels were washed 4 times in acetone (Technical Grade, Univar) baths. Xerogels were formed by drying washed gels ambiently for several days followed by placing samples under vacuum for 6 hr at 50° C. to remove residual solvent. Aerogels were formed by drying washed gels in a Spe-ed SFE supercritical fluid CO₂ dryer from Applied Separations. Mechanically-strong X—VOₓ aerogels were formed using a solution of 5.5 g Desmodur N3200A (Bayer) in 94 mL dry acetone (CHROMASOLV for HPLC, Sigma-Aldrich), followed by washing in acetone and supercritical CO₂ drying.

Mesophase ¹³C (100 MHz) nuclear magnetic resonance (NMR) was performed on wet gels using a Varian Unity Inova with ¹H (400 MHz) decoupling. No nuclear Overhauser enhancement was utilized in order to maintain quantitative ¹³C signal intensity. The terminal CH₃ on EtOH (18.3 ppm vs. tetramethylsilane (TMS)) was used as an internal reference.

¹H (400 MHz) NMR was used to characterize VOCl₃ solutions in CCl₄ and EtOH with various amounts of ECH, to analyze V^{V} chelates which form prior to gelation. These solutions were made by dissolving 0.090 mL VOCl₃ in 1 mL of the appropriate solvent (CCl₄ or EtOH) to which was added stoichiometric amounts of ECH and/or EtOH. The terminal CH₃ on EtOH (1.21 ppm vs. TMS) and the high-field proton on ECH (2.70 vs. TMS in ¹H) were used as internal references.

### Example 15

### VO₂ Film Fabrication

A precursor solution was prepared by omitting H₂O from a typical gel sol, i.e., 0.180 mL VOCl₃ and 0.750 mL ECH in 2 mL EtOH. Amorphous VOₓ films were formed by spin coating the precursor solution onto 1-in diameter quartz or 1 cm square n-doped silicon substrates (Ted Pella), utilizing ambient moisture to affect hydrolysis. Films were dried in a 150° C. oven in air for 10 min. Films were then annealed under dry N₂ at 400° C. for 2 hr to form crystalline monoclinic VO₂.

### Example 16

### Materials Characterization

Bulk gel densities (ρ_{b}) were determined from sample mass and dimensions. Skeletal densities (ρₛ) were determined via He pycnometry using a Micromeritics AccuPyc II 1340. N₂ sorption porosimetry was carried out on a Micromeritics ASAP 2020 surface area and porosity analyzer using monoliths broken into small chunks. Specific surface area (σₘ) was determined using the Brunauer-Emmett-Teller (BET) method, and the pore size distribution was determined using the Barrett-Joyner-Halenda (BJH) method. Prior to pycnometry and porosimetry measurements, samples were outgassed for 24 hr at 40° C. under vacuum.

Gel and film nanomorphology was analyzed using cross-sections mounted in a Hitachi S-4700 scanning electron microscope (SEM). Monoliths were ground to a fine powder using a mortar and pestle before performing powder X-ray diffraction (XRD) with a PANalytical X'Pert Pro Multi-Purpose Diffractometer, attached Cu K_{α} (λ=1.54 Å) radiation source. Ground powders were dispersed in acetone and deposited onto a silky-carbon-coated Cu grid for transmission electron microscopy (TEM) and electron diffraction (ED) on a Technai F20 STEM.

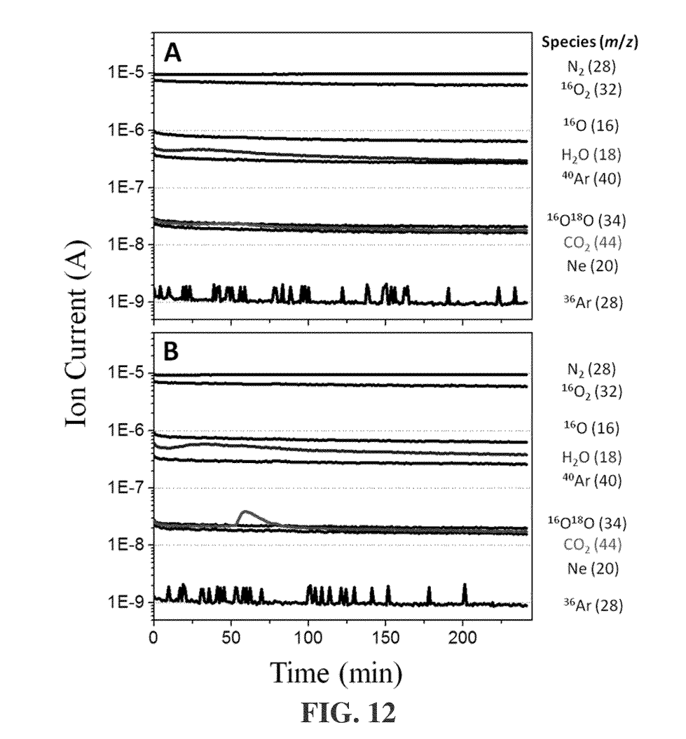

Tandem thermogravimetric analysis-mass spectrometry (TGA-MS) was carried out on a Netzsch STA 409 C thermogravimetric analyzer connected via a fused silica capillary to a QMS 403 C mass spectrometer under air at a heating rate of 5° C./min. Ion currents were monitored for 15<m/z<300. Signals were normalized by carrier gas ion current (N₂, m/z=28) and sample mass for comparison between runs. Only signals for m/z=18 and m/z=44 were detectable above background (See FIG. 12).

Referring to FIG. 12, raw MS signals between m/z=15 and m/z=300 are above the detection limit (ca. 10⁻¹⁰ A). While TGA was performed under flowing N₂, MS (and the presence of oxidation in TGA) shows clear evidence of a significant air leak, effectively rendering the TGA atmosphere equivalent to air. All identified signals are listed and identified in order of intensity at right, with isotopes labeled where more than one is observed. The ratios of the species are consistent with both typical concentrations in air and natural isotopic abundancies. For TGA-MS analysis, signals due to air were removed by subtracting the m/z=36 signal multiplied by the final measured ratio between each species. Only m/z=18, H₂O, (blue) and m/z=44, CO₂, (red) show any significant deviation from the air background. These signals were normalized by sample mass and m/z=28 ion current, to account for variations in carrier gas flow. Latency between TGA and MS signals was determined to be 6 min by matching maxima in the mass-loss derivatives to maxima in the H₂O and CO₂ ion currents.

### Example 17

### Gelation

Gelation is highly exothermic and extremely rapid (<10 sec), resulting in bright red, glassy monoliths. Cooling the precursor sol to −48° C. in a Dry Ice-acetone bath prevented gelation (maintained fluidity for 10 min in bath), but upon removal from the cooling bath, i.e., to pour into molds, exothermic runaway caused gelation in under a minute.

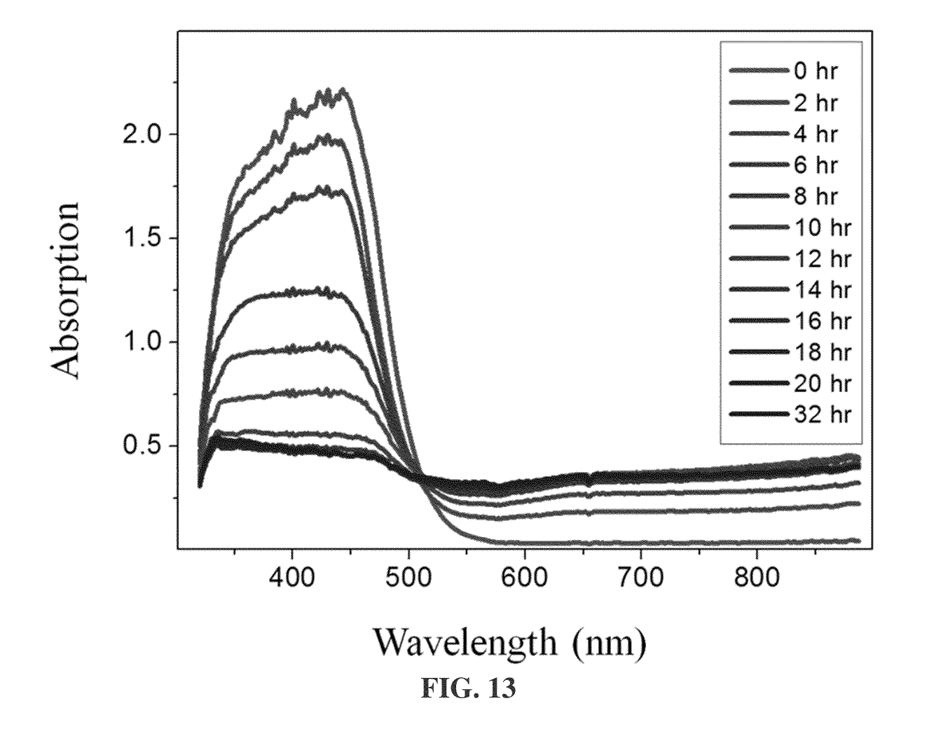

Referring to FIG. 13, UV-Vis absorption spectra of standard epoxide gel during aging are shown. Short-path-length (20-30 μm) soda-lime glass cuvettes were fabricated to limit absorption and sealed with Parafilm after filling with mixed precursor sol. No significant changes to absorption were detected after ca. 16 hr. Gels become dark green after several hours of aging, losing translucency due to high absorption. Without being bound by theory, the color change is attributed to the partial reduction of red hydrated V^{V} to deep blue V^{IV} common in nonaqueous VOₓ gels. Acetaldehyde, as an oxidative product of EtOH, is thought to be the primary organic oxidation product, detectable by its distinctive scent (sour apples) readily apparent in unwashed wet gels. Gels underwent minimal (clear) syneresis, and all acetone washes were colorless. No measurable shrinkage was observed during aging or supercritical drying.

### Example 18

### H₂O and Epoxide Optimization

Precursor sol compositions along with corresponding gelation rate and gel quality are summarized in Table 2.

TABLE 2
Results of H₂O optimization and investigation of alternative cyclic ethers.

| | VOCl₃ | Epoxide | H₂O | | |
|---|---|---|---|---|---|
| | (eq.) | (eq.) | (eq.) | Gelation Time | Gel Quality |
| | 1 | 5 (ECH) | 6 | ~10 s | Turbid |
| Standard | 1 | 5 (ECH) | 9 | <10 s | Glassy |
| Formulation | (0.540 mL) | (2.25 mL) | (0.925 mL) | | |
| (6 mL EtOH) | (5.71 mmol) | (28.6 mmol) | (51.4 mmol) | | |
| 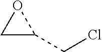 | 1 1 | 5 (ECH) 5 (ECH) | 12 20 | <10 s <3 s | Glassy Inhomogeneous |
| 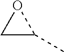 | 1 | 5 (PPO) | 9 | Instantaneous | Inhomogeneous |
| 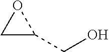 | 1 | 5 (GLY) | 15 | 15 min | Glassy, Fragile |
| 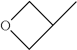 | 1 | 5 (DMO) | 12 | 10 min | Very Turbid |

H₂O content in the standard gel formulation was optimized to lengthen gelation time while maintaining optical quality (homogeneity). Increasing the H₂O:VOCl₃ ratio was found to increase the gelation rate, at the extreme of which (20:1) gelation occurred faster than the mixing of the precursor solutions, resulting in macroscopically inhomogeneous gels. Lowering the ratio (6:1) was found to produce turbid gels (microscopic inhomogeneity). It was also necessary to add ECH and H₂O to the VOCl₃ solution simultaneously, as adding them sequentially in either order produced macroscopically inhomogeneous gels.

It has been observed that modifying epoxide functionality at the a position and utilizing less-strained 1,3-epoxides can alter gelation rate. Several commercially available alternatives were investigated, as a slower gelation rate would improve ease of fabrication. Replacing ECH with PPO significantly increased the gelation rate, leading to instantaneous gelation and the formation of inhomogeneous solid droplets. GLY significantly slowed gelation (15 min), but the resulting gels were extremely fragile and crumbled even without handling during washing. GLY gels also exhibited both colored syneresis liquid and washes, which may be attributed to improved vanadium oxide chelation in polyols formed from glycidol ring opening. DMO significantly slowed gelation and gels remained robust, though entirely opaque. The opacity in these gels may be ascribed to phase separation of the neopentanol formed from ring opening, leading to microscopic inhomogeneities and scattering.

### Example 19

### Mesophase ¹³C NMR

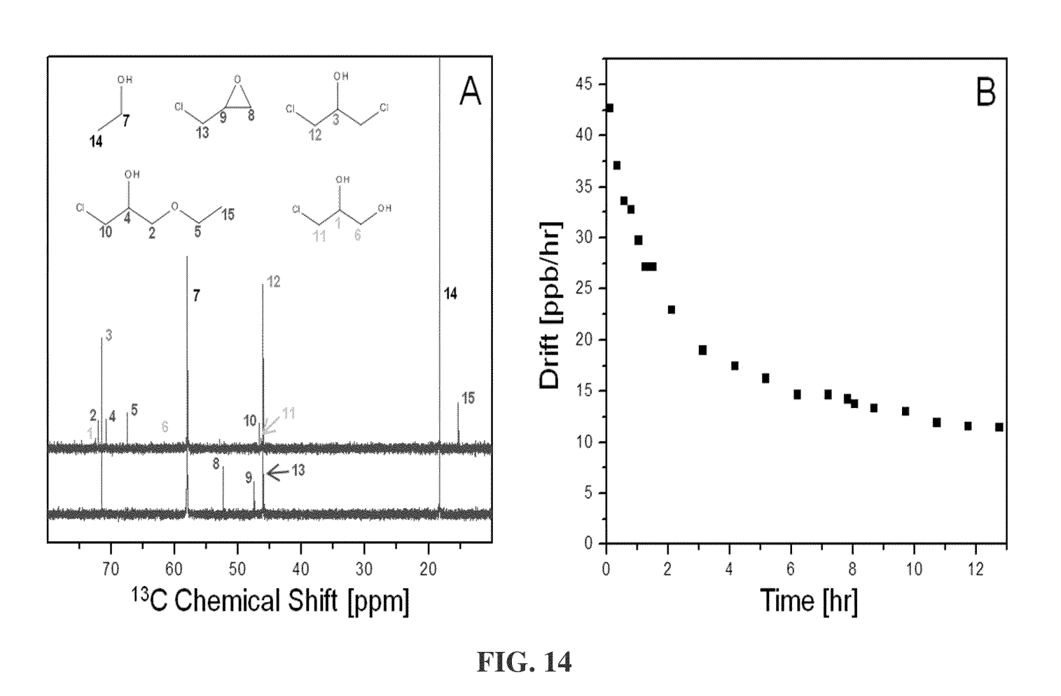

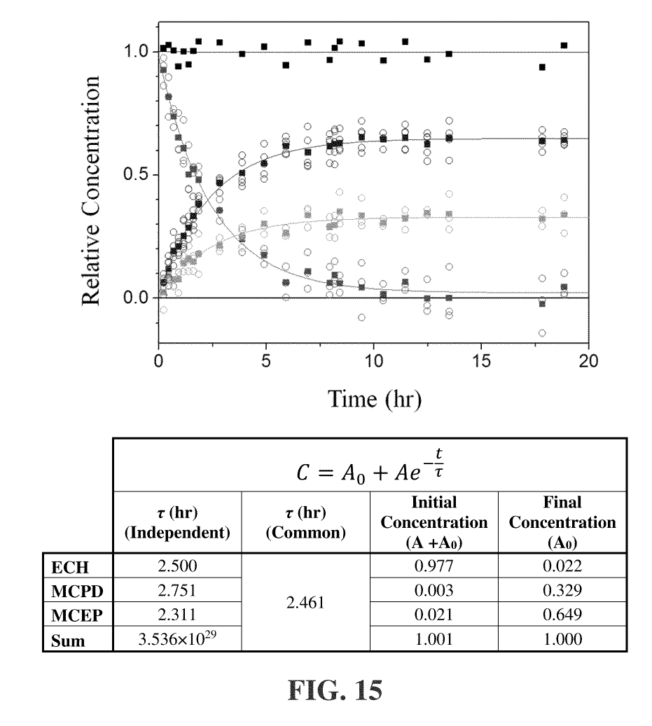

While gelation occurs too quickly to monitor, gel aging can be monitored via in situ mesophase NMR to identify organic reaction products and their formation rates. All major organic species in the gel effluent were identified (FIG. 14A). No redox products were detected via ¹³C or ¹H NMR due to their low concentration and the unavoidably large peak width caused by anisotropic susceptibility broadening (ASB). The spectra confirm that Cl⁻ scavenging occurs through nucleophilic attack on the less-substituted carbon of the epoxide ring, as is typically observed in epoxide-assisted gelation, forming 1,3-dichloro-2-propanol (DCP). DCP peak areas were constant throughout aging, indicating that Cl⁻ scavenging occurred before the first spectrum could be collected (5-15 min after gelation). Over the course of aging, excess ECH underwent nucleophilic attack by H₂O and EtOH, forming 1-chloro-2,3-propane diol (MCPD) and 1-chloro-(ethoxy)propanol (MCEP), respectively. This experiment is unable to discern the ring-opening mechanism in these cases: attack on either epoxy carbon by H₂O results in identical products and the 2-ethoxy-3-ol and 3-ethoxy-2-ol have nearly identical ¹³C and ¹H chemical shifts. Time-dependant concentrations of ECH and its ring-opened products follow exponential behavior (see FIG. 15), which may be taken as indicating that ring-opening follows ECH-limited first-order reaction kinetics.

Referring to FIG. 15, the concentration (C) of ECH (red), MCPD (orange), MCEP (blue) and their Sum (black) as a function of time (t) as monitored by ¹³C NMR are shown. Individual peak intensities (open circles) were averaged (filled squares) to determine the concentration of each species. All intensities were normalized to the time-averaged Sum to determine relative concentration. Data was independently fitted to an exponential decay (shown in the table of FIG. 15). Noting that each of the time constants (τ) was similar-excepting the Sum for which τ≈∞—this parameter was constrained to be shared and the data was refit. The fits (solid line) are excellent (R²=0.994) and physically consistent: the sum of the fitted concentrations matches the fit of the Sum, which has negligible (A=8.81566×10⁻⁴) exponential character. This result may indicate that ECH ring-opening is first-order with respect to ECH concentration. As both H₂O and EtOH are present in large excess, changes in their concentration by consumption during ring-opening would have little effect on the observed kinetics. This may demonstrate that concentration curves can be monitored via ¹³C NMR for analysis of slow gelation kinetics, even in the presence of poor signal to noise caused by low concentrations and anisotropic susceptibility broadening. Though in this instance, the species monitored are not believed to play a direct role in gelation.

Drift of the reference peak was monitored as a function of time (FIG. 14B). Peak drift is caused by two processes: natural drift of the superconducting magnet field which is linear (constant drift rate) over this time interval and changes in bulk magnetic susceptibility of the matrix. The positive, time-dependent peak drift is consistent with the reduction of diamagnetic V^{V} to paramagnetic V^{IV}. While this experiment cannot differentiate between paramagnetic and diamagnetic susceptibility, diamagnetic changes, e.g., caused by ECH ring-opening, are small in comparison to what is observed. This result may be qualitatively consistent with the observed color change during gel aging (see FIG. 13).

### Example 20

### Epoxide Ring-Opening in H₂O-Free Sols

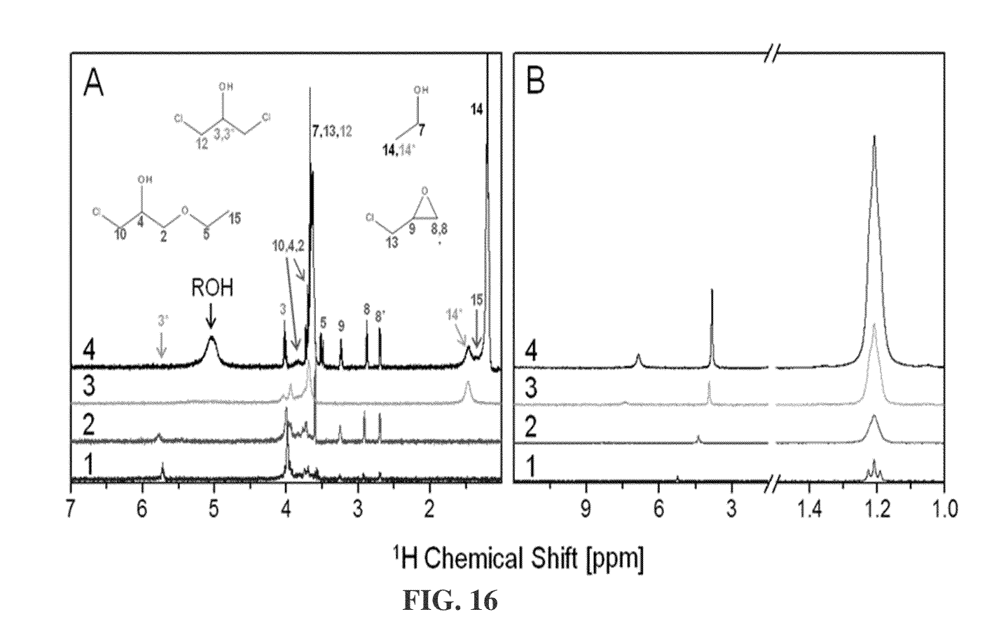

¹H NMR of VOₓ gel precursors without H₂O (FIG. 16A) shows epoxide ring-opening occurs in the absence of an acidic metal hydrate. A reaction is also evident in the color changes that occur when adding ECH to VOCl₃ solutions: orange to pale yellow in the absence of EtOH and red to pale yellow in the presence of EtOH. Solution A4, a standard gel formulation absent H₂O, clearly shows the formation of DCP, but, while the absence of ASB increases peak resolution, several peaks lay within a small chemical shift range, ca. 3.5-3.7 ppm, overlapping with the intense EtOH methylene. CCl₄ was used as an inert, non-coordinating solvent with no ¹H signal in an attempt to resolve these peaks and observe EtOH-free chelates.

TABLE 3
Composition of solutions in FIG. 16.

| | | VOCl₃ | ECH | EtOH |
|---|---|---|---|---|
| Spectrum | Solvent | (eq.) | (eq.) | (eq.) |
| A1 | CCl₄ | 1 | 3.1 | 0 |
| A2 | CCl₄ | 1 | 5 | 0 |
| A3 | CCl₄ | 1 | 3.1 | 3 |
| A4 | EtOH | 1 | 5 | 18 |
| B1 | CCl₄ | 1 | 0 | 1 |
| B2 | CCl₄ | 1 | 0 | 3 |
| B3 | CCl₄ | 1 | 0 | 10 |
| B4 | EtOH | 1 | 0 | 18 |

The electron-withdrawing effect of the V^{V} center on ligands can be most directly observed in the VOCl₃-EtOH system (FIG. 16B). As the EtOH:VOCl₃ ratio decreases, EtOH is proportionally more likely to be found coordinated to V^{V} and consequently shifted downfield, the methylene protons more so than the methyl protons. The methyl triplet is only resolved in the solution with lowest EtOH:VOCl₃ ratio, and hence strongest V^{V}-EtOH interaction, which may be taken to imply that exchange, as opposed to nuclear or electronic effects, is the dominant broadening mechanism. It may then be inferred that species with well-resolved peaks do not exchange significantly between the solvent and V^{V} ligand (or solvation) shell. This conclusion may be consistent with the observed peak resolutions in solutions A4, where, due to its high concentration, EtOH is effectively the sole ligand, and A3, where DCP and EtOH exchange rapidly. The anomalous peak in solutions A4 and A3 (14*) is the proportion of EtOH active in exchange over the timescale of the experiment. The high resolution of the ECH peaks in all cases means that ECH does not coordinate strongly to V^{V}, implying that peak 3*(quintet) is attributable to DCP ligands bound to the electron-withdrawing V^{V} and not chelated ECH.

### Example 21

### Ultra-Low-Density VOₓ Gels

Ultra-low-density VOₓ gels were fabricated by reducing the VOCl₃ concentration in the standard formulation (Table 4). Reducing the ECH and H₂O concentrations to maintain stoichiometric ratios reduced the quality of gels and in some cases caused a failure of gelation. Gels could only be made from sols with nominally constant concentrations of ECH and H₂O. Curiously, the lowest density gels passed through three distinct phases, forming a soft red gel initially (ca. 5 min), followed by a dissolution of the solid matrix and reduction to form a deep green sol (ca. 24 hr), and eventual formation of a stable deep green gel (ca. 7 d). Unfortunately, ultra-low-density aerogels could not be fabricated, as these wet gels collapsed during super-critical CO₂ drying.

TABLE 4
Results of attempts to fabricate ultra-low-density gels.

| Nominal Gel | | | | | Result |
|---|---|---|---|---|---|
| Density | EtOH | VOCl₃ (eq.) | ECH (eq.) | H₂O (eq.) | (after 5 days aging) |
| Standard | 6 mL | 1 | 5 | 9 | glassy, dark green gel |
| | | (0.540 mL) | (2.25 mL) | (0.925 mL) | |
| 1/2 density | 6 mL | 0.5 | 2.5 | 4.5 | very turbid, green gel |
| | 6 mL | 0.5 | 2.5 | 9 | turbid, green gel |
| | 6 mL | 0.5 | 5 | 4.5 | glassy, green gel |
| | 6 mL | 0.5 | 5 | 9 | glassy, dark green gel |
| 1/10 density | 6 mL | 0.1 | 0.5 | 0.9 | red sol |
| | 6 mL | 0.1 | 0.5 | 9 | green flocc |
| | 6 mL | 0.1 | 5 | 0.9 | orange sol |
| | 6 mL | 0.1 | 5 | 9 | dark green sol (gels in 7 days) |

### Example 22

### Physical Properties

Nanomorphology, Surface Area, and Porosity. Dried aero- and xerogels are so dark as to appear black (FIG. 11) and streak dark green. Upon exposure to air for several months, aerogel monoliths become lighter and noticeably green. This change can be temporarily reversed by heating the monoliths to 100° C. under vacuum for 24 hr and may be attributed to reversible H₂O absorption.

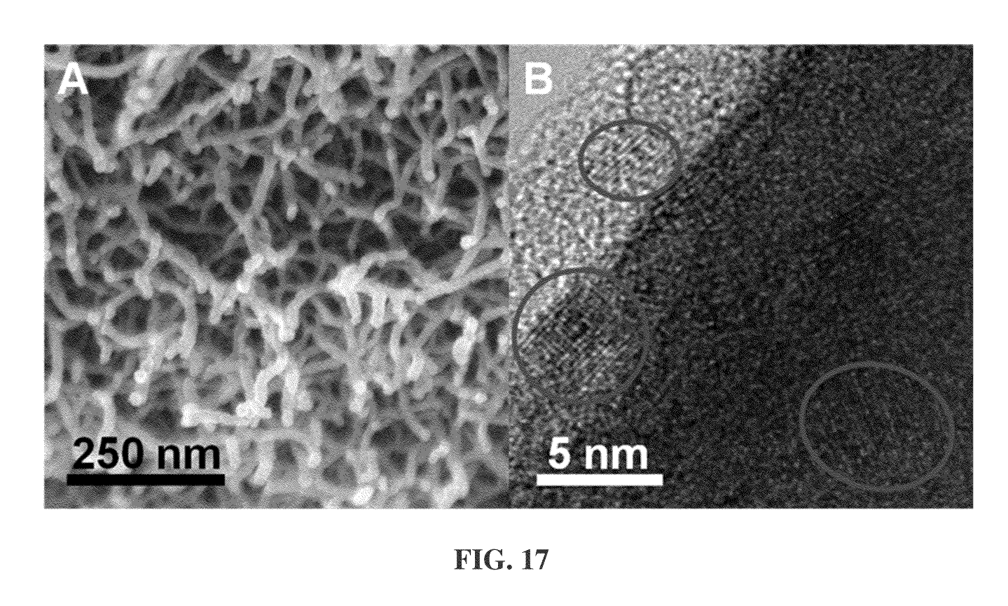

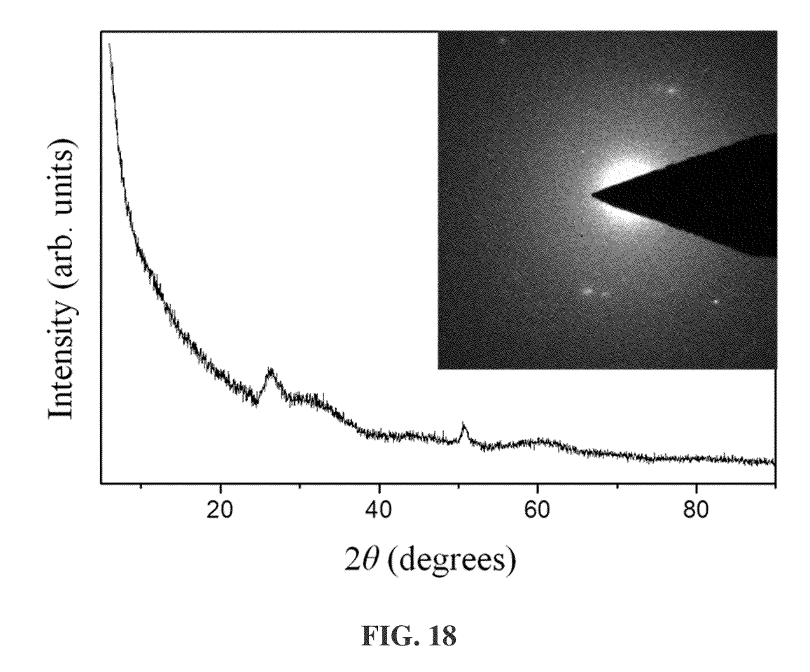

The macroporosity and micromorphology of the gels can be seen in FIG. 17. The fabricated aerogels have the same unique nanoworm morphology seen occasionally in gels fabricated via alkoxide hydrolysis. TEM shows small crystalline domains dispersed in an amorphous matrix, consistent with both XRD and ED (See FIG. 18). Both are consistent with sparse, intermittent crystalline domains in an amorphous matrix, as is seen in TEM images.

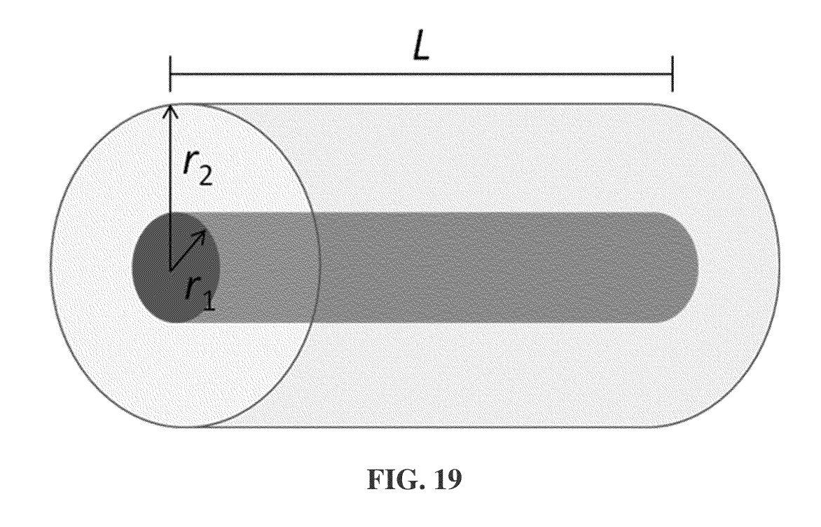

Like their alkoxide counterparts, epoxide gels can be conformally coated with polymer using bifunctional isocyanates, to form X—VOₓ aerogels. These gels maintain a high specific surface area and are mechanically comparable to X—VOₓ aerogels synthesized via hydrolysis of vanadium oxiytripropoxide (See FIG. 19).

Referring to FIG. 19, this figure shows the conformally coated cylindrical VOₓ nanoworm approximation used to calculate polymer coating density, where r¹ and r₂ are the radii of the nanoworms and before and after isocyanate crosslinking, respectively and L is the length of the nanoworms. Since conformal crosslinking only adds onto existing nanoworms, the ratio of the radii can be determined from the ratio of the volumetric surface area, σᵥ, according to the following equation:

$$\frac{{r}_{2}}{{r}_{1}} = \frac{2 π {r}_{2} L}{2 π {r}_{1} L} = \frac{{σ}_{v , 2}}{{σ}_{v 1}} = \frac{33.7}{10.5} = 3.21$$

The density of the composite nanoworm, ρ_{s,T}, is the average of the density of the composite parts, ρ_{s,1} and ρ_{s,2}, weighted by their respective volumes, V₁ and V₂, according to the following equation:

$$\begin{matrix}{ρ}_{s , T} = 1.32 \\ = \frac{{ρ}_{s , 1} {V}_{1} + {ρ}_{s , 2} {V}_{2}}{{V}_{1} + {V}_{2}} \\ = \frac{{ρ}_{s , 1} 2 π {r}_{1}^{2} L + {ρ}_{s , 2} 2 π ( {r}_{2}^{2} - {r}_{1}^{2} ) L}{2 π {r}_{2}^{2} L} \\ = \frac{3.30 {r}_{1}^{2} + {ρ}_{s , 2} ( {( 3.21 {r}_{1} )}^{2} - {r}_{1}^{2} )}{{( 3.21 {r}_{1} )}^{2}} \\ = \frac{3.30 + 9.30 {ρ}_{s , 2}}{10.3} ⇒ {ρ}_{s , 2} \\ = 1.11 [ g \text{/} {cm}^{3} ]\end{matrix}$$

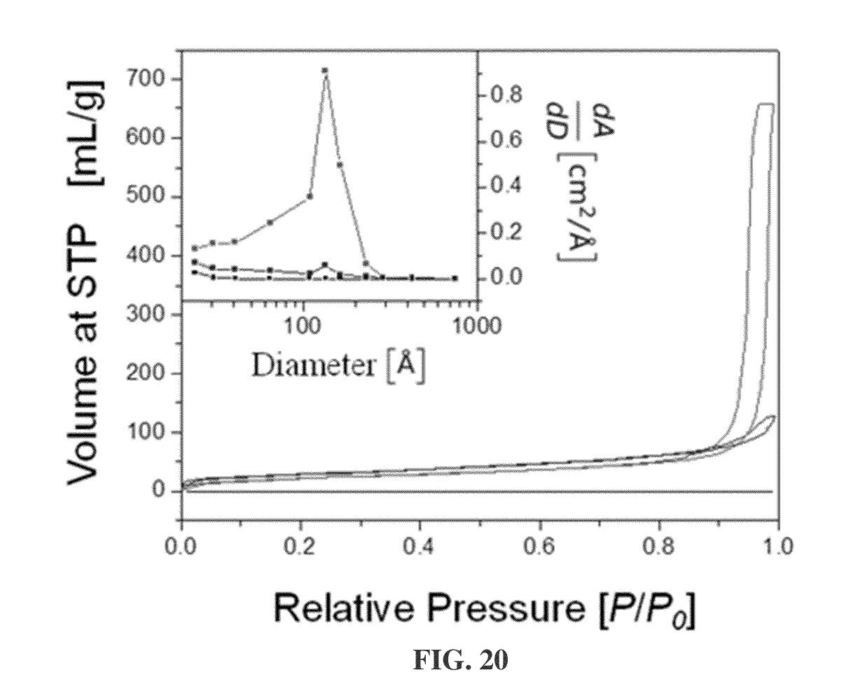

BET analysis of N₂ porosimetry of aero- and xerogels (FIG. 20; Table 5) indicates that pores collapse entirely during bench drying. The skeletal density of the VOₓ xerogels is significantly lower than that of the aerogels, indicating the formation of closed pores during collapse. X—VOₓ aerogels possess a lower specific surface area and a higher mesopore density than their native counterparts. This apparent contradiction is explained by carefully considering the geometric effects of the conformal polymer coating on the VOₓ matrix, adding mass, which scales volumetrically, faster than surface area, resulting in a reduced gravimetric surface area, while decreasing pore size, forming mesopores from macropores. Utilizing the bulk volumetric surface area of the aerogels (σᵥ=σₘρ_{b}), it can be seen that the total surface area of the monoliths increases with crosslinking, as would be expected from a conformal coating. Using these physical properties and approximating VOₓ nanoworms as cylinders (See FIG. 19), the density of the polymer coating was calculated to be 1.11 g/cm³, consistent with the skeletal density of polyurea aerogels fabricated from N3200A (1.15 g/cm³).

TABLE 5
Physical properties of VOₓ and X-VOₓ gels.

| | ρ_{b} | ρₛ | Porosity | σ ₘ | σ ᵥ |
|---|---|---|---|---|---|
| | (g/cm³) | (g/cm³) | (1-ρ_{b}/ρₛ) | (m²/g) | (m²/cm³) |
| VOₓ Xerogel | — | 2.67 | — | 0.31 | — |
| VOₓ Aerogel | 0.103 | 3.30 | 0.969 | 102.0 | 10.5 |
| X-VOₓ Aerogel | 0.412 | 1.32 | 0.688 | 81.9 | 33.7 |

### Example 23

### Solvent Trapping and H₂O Content

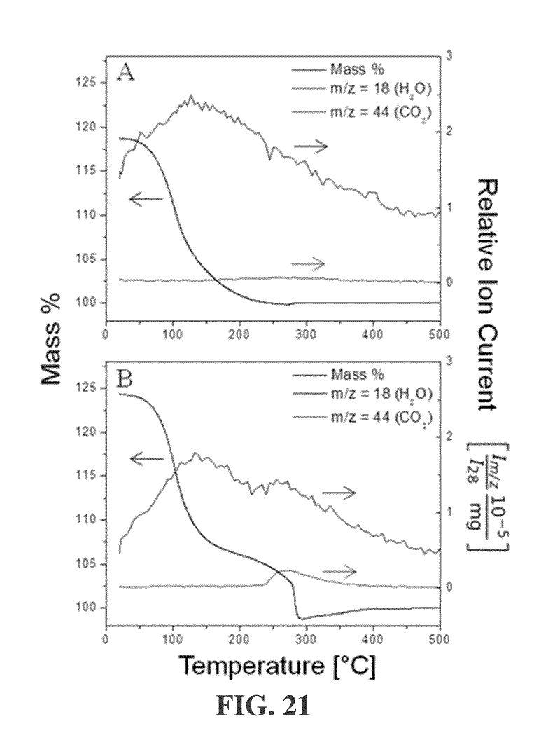

TGA-MS reveals a significant difference between VOₓ aerogels and xerogels (FIG. 21). Both gels showed significant mass losses around 100° C., coincident with the evolution of H₂O (m/z=18), but xerogels show an additional mass loss above 200° C., corresponding to the release of CO₂ (m/z=44) along with H₂O, which varied in shape between measurements. Combined with the skeletal density measurements implying closed porosity, and without being bound by theory, it is surmised that these pores are filled with organic residue, likely acetone, which undergoes complete combustion, possibly catalyzed by VOₓ, in the oxygen-rich atmosphere. The unusual and inconsistent shape of the TGA signal may be attributed to the fact that the closed pores do not rupture simultaneously and are not macroscopically uniform, leading to differences between samples even when collected from a single gel. The possibility that the CO₂ represents the decomposition of a carbonate, formed by reaction of CO₂ with the amphoteric oxide, or physisorbed CO₂ was considered and rejected, as, if that were the case, aerogels (formed by immersion in liquid CO₂) would show a higher relative concentration of CO₂, instead of the negligible amount that is observed. TGA also shows that H₂O content, indicated by the magnitude of the low-temperature loss, relative to the VOₓ matrix is the same for both aero- and xerogels. Since aerogels possess several orders of magnitude higher surface area, it is believed that this H₂O cannot be surface-adsorbed and must be bound inside the VOₓ matrix. This H₂O appears to be loosely bound and its removal reversible, as evinced by the reversible color change of aerogel monoliths under repeated cyclic exposure to air and 100° C. vacuum.

### Example 24

### Film Morphology

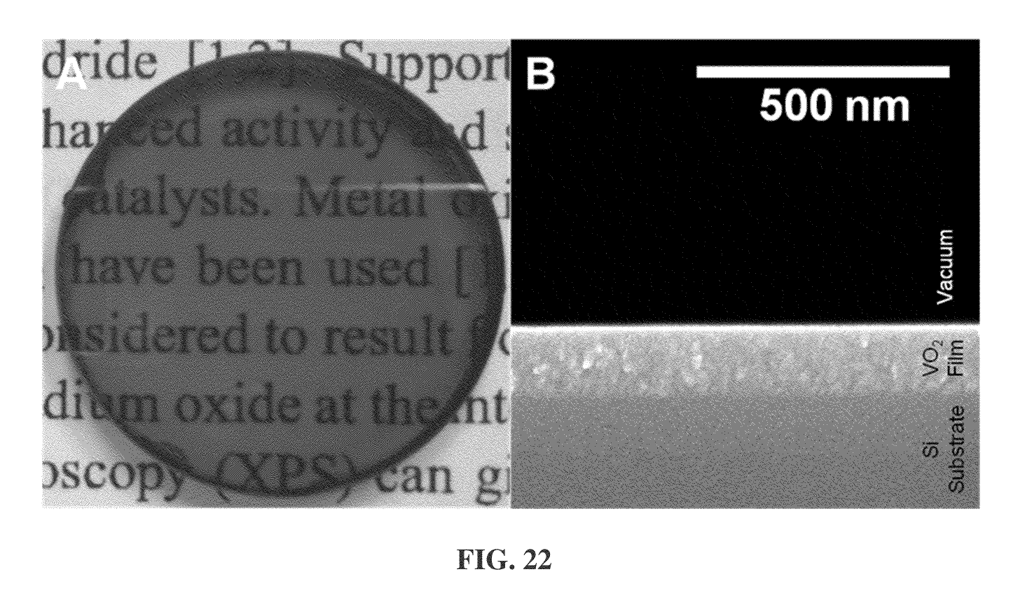

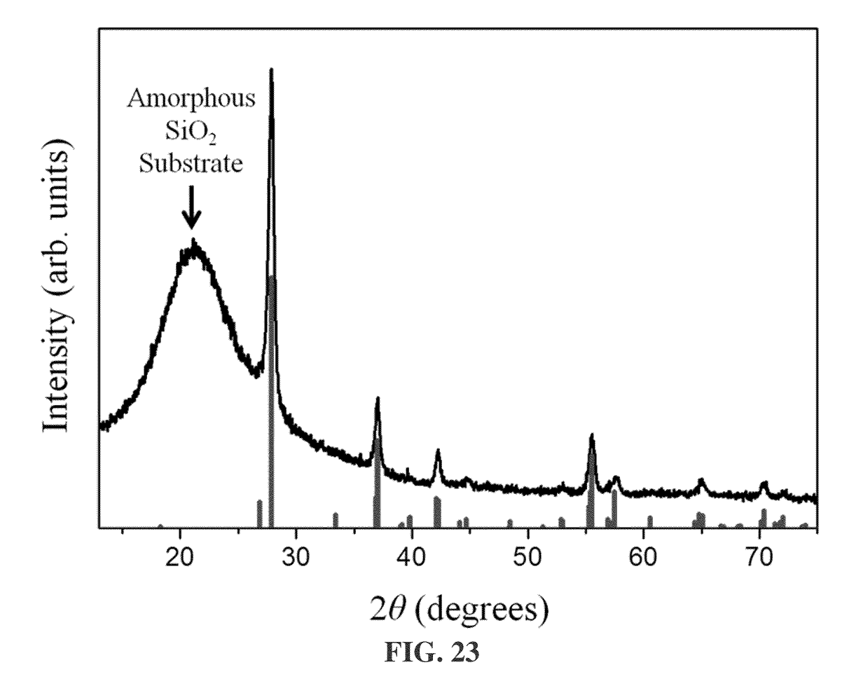

Highly uniform, smooth, dense films were fabricated by spin-coating the modified precursor sol (FIG. 22) and determined to be crystalline monoclinic VO₂ via XRD (See FIG. 23), a method analogous to that of Guzman et al. (Materials Research Bulletin, 1994, 29(5), 509-515)). It was found that VOₓ films undergo complete reduction without the need for a reducing atmosphere, likely due to organic residues with low volatility under ambient conditions.

### Example 25

### VO₂ Film Metal-to-Insulator Transition

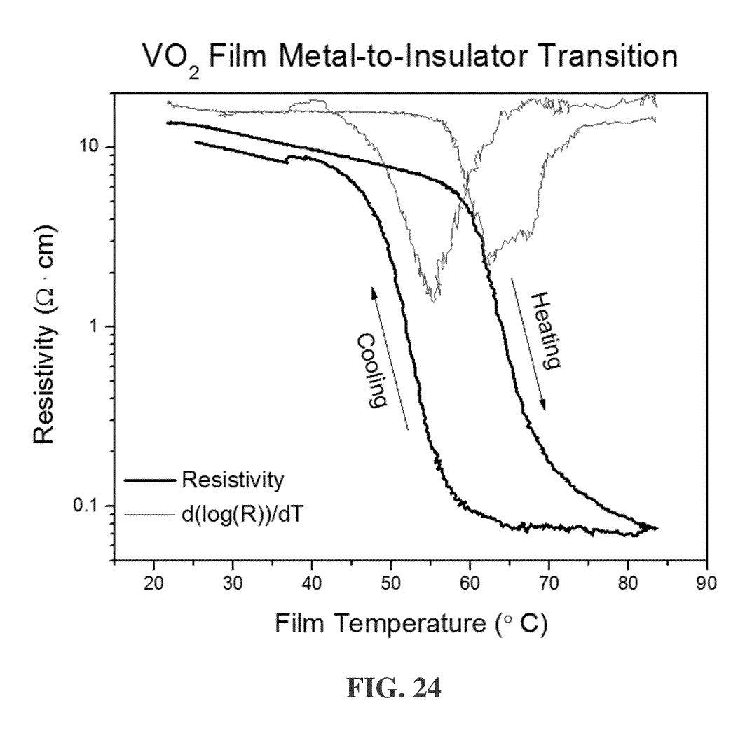

Measurement of the metal-to-insulator transition of fabricated ˜150 nm VO₂ thin film on a quartz substrate is displayed in FIG. 24. Resistivity of the film was measured using the four-point-probe technique with a 1 mm probe separation and a current of 14 nA on a controlled heating stage. A resistivity change of two orders of magnitude was observed at 65° C. upon heating and 55° C. upon cooling.

### Example 26

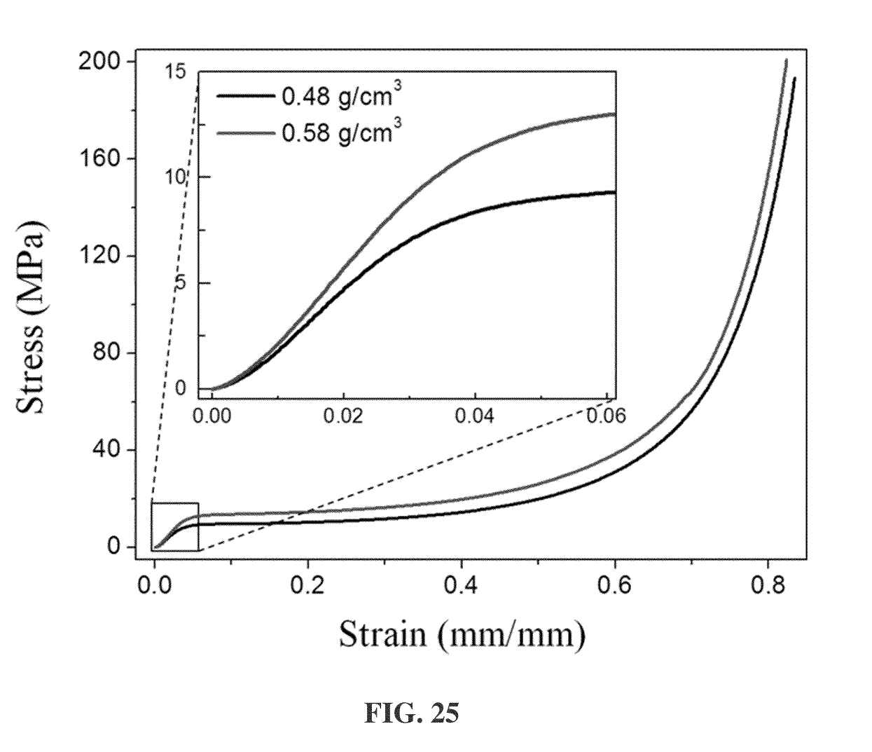

Epoxide gels exhibit several other differences from their alkoxide counterparts. Wet epoxide gels are sturdier (easier to handle during washing) and exhibit less optical scattering than their alkoxide counterparts. While X—VOₓ epoxide aerogels possess mechanical properties similar to X—VOₓ alkoxide aerogels (see FIG. 25), mechanical failure occurred at a lower strain in epoxide X—VOₓ aerogels. Without being bound by theory, it is believed that this premature failure is attributed to internal voids, which are not present in alkoxide X—VOₓ aerogels. It is suspected that these voids are formed by solvent vaporization during exothermic aging.

### Example 27

### Additional Observations

Without being bound by theory, the observation herein that robust, homogeneous gels can be fabricated over a large range of densities only using sols with nominally constant concentrations of ECH and H₂O added simultaneously may suggest that epoxide ring-opening and hydrolysis occur on similar timescales, unlike what has been previously reported in other metal oxide systems. While it is proposed that acidic transition metal hydrates protonate the epoxide ring before nucleophilic attack, ring opening is observed in the VOCl₃-ECH system in the absence of the H₂O, i.e., absent acidic hydrates, and even in fully aprotic systems, in which epoxide protonation is precluded, which may be taken to indicate that epoxide protonation is not necessary for ring-opening. Instead, it is possible that V^{V}-Lewis-acid catalysis may be solely responsible for ring opening in these aprotic systems and that transition metal Lewis-acid catalysis may contribute to epoxide ring-opening in other transition metal oxide systems. This may be supported by the observation that the addition of H₂O after PPO in epoxide-assisted gelation of Fe₂O₃ leads to a gelatinous precipitate instead of a rigid gel, suggesting that FeCl₃ reacts with PPO before the addition of H₂O.

Without being bound by theory, the intermediate fluid phase of the lowest density gel may suggest that multiple discreet processes take place at disparate timescales in all gels. First, fast formation of a red V₂O_{5·x}H₂O gel driven by V^{V} hydration and epoxide-driven ion scavenging. Second, partial or complete dissolution of the V^{V} oxide matrix in concert with or followed by V^{V}→V^{IV} reduction by chelated EtOH. Finally, precipitation or gelation of blue-green V^{IV/V} oxide, possibly driven by changes in solvent properties brought on during ECH hydrolysis and ethanolysis.

While it may be possible that V^{V}→V^{IV} reduction occurs, evinced by gel color, acetaldehyde formation, and magnetic susceptibility evolution, the exact degree of reduction has proven difficult to quantify; the synthesized VOₓ is not stable under conditions necessary for measurement, e.g., aqueous redox titration, XPS, or laser Raman spectroscopy. Nevertheless, the significantly darker color of the dried gels and their dispersed solids as compared with previously-synthesized alkoxide gels, suggests that it is possible that significantly more reduction occurs in epoxide gels, which may be reflective of efficient V^{V}-EtOH redox chemistry.

While the disclosure has been illustrated and described in detail in the figures and foregoing description, the same is to be considered as illustrative and not restrictive in character, it being understood that only selected embodiments have been shown and described, and that all changes, modifications and equivalents that come within the spirit of the disclosures described heretofore and/or defined by the following claims are desired to be protected, including any variations, uses, or adaptations that follow the general principles herein, and such departures as come within known or customary practice within the art to which the present disclosure pertains. In addition, all publications cited herein are indicative of the level of skill in the art, and are hereby incorporated by reference in their entirety as if each had been individually incorporated by reference and fully set forth.

What is claimed is:

1. A method for preparing vanadium oxide aerogels comprising the steps of:
(i) obtaining wet gels by mixing a vanadium halide of the formula VOX₃, water, and one or more acid scavenger species in one or more appropriate solvent at an appropriate temperature and allowing the liquid solution to form a gel monolith;
(ii) washing the gels in a solvent bath to remove unreacted materials; and,
(iii) critically drying the washed wet gels to obtain aerogels;
wherein X is a halogen.

2. The method of claim 1 wherein X═Cl.

3. The method of claim 1 wherein the one or more acid scavenger species is an epoxide.

4. The method of the preceding claim wherein the epoxide is selected from the group consisting of epichlorohydrin, propylene oxide, glycidol, and dimethyloxetane.

5. The method of the preceding claim wherein the epoxide is epichlorohydrin.

6. The method of claim 1 wherein the one or more appropriate solvent is a water-miscible organic solvent that does not decompose upon contact with the vanadium halide of the formula VOX₃.

7. The method of the preceding claim wherein the solvent is an alcohol.

8. The method of the preceding claim wherein the solvent is ethanol.

9. The method of claim 1 wherein the appropriate temperature is a temperature in the range of from about −78° C. to about 25° C.

10. The method of claim 1 wherein the solvent in the solvent bath is a fluid that is miscible with the utilized reactants and byproducts and that has an accessible supercritical point, or that can be exchanged with another fluid that has an accessible supercritical point.

11. The method of the preceding claim wherein the solvent in the solvent bath is a ketone.

12. The method of the preceding claim wherein the solvent in the solvent bath is acetone.

13. The method of claim 1 further comprising the step of subjecting the gels to crosslinking conditions in bifunctional isocyanate solutions.

14. A method for preparing vanadium oxide films comprising the steps of:
(i) obtaining a stable solution by mixing a vanadium halide of the formula VOX₃ and one or more acid scavenger species in one or more appropriate solvent at a temperature of from about −78° C. to about 25° C.;
(ii) spin coating the solution onto a substrate to form soft films;
(iii) drying in air at a temperature of from about 50° C. to about 200° C., for a time period of from about 5 minutes to about 30 minutes; and,
(iv) annealing under dry N₂ at a temperature of from about 350° C. to about 500° C. for at least 1 hour;
wherein X is a halogen.

15. The method of claim 14 wherein the one or more acid scavenger species is an epoxide.

16. The method of the preceding claim wherein the epoxide is selected from the group consisting of epichlorohydrin, propylene oxide, and glycidol.

17. The method of the preceding claim wherein the epoxide is epichlorohydrin.

18. The method of claim 14 wherein the one or more appropriate solvent is an organic solvent that is miscible with the vanadium halide of the formula VOX₃, the one or more acid scavenger species, and the resulting stable solution, without undergoing decomposition.

19. The method of the preceding claim wherein the appropriate solvent is selected from the group consisting of ethanol, dimethylformamide, and CCl₄.

20. A vanadium oxide aerogel prepared by a process comprising the steps of:
(i) obtaining wet gels by mixing a vanadium halide of the formula VOX₃, water, and one or more acid scavenger species in one or more appropriate solvent at an appropriate temperature and allowing the liquid solution to form a gel monolith;
(ii) washing the gels in a solvent bath to remove unreacted materials; and,
(iii) critically drying the washed wet gels;
wherein X is a halogen.
